(19) United States
(12) Patent Application Publication
(10) Pub. No.: US 2024/0076789 A1
(43) Pub. Date: Mar. 7, 2024

(54) ELECTROLYSIS SYSTEM

(71) Applicant: Schlumberger Technology Corporation, Sugar Land, TX (US)

(72) Inventor: David Snoswell, Cambridge (GB)

(21) Appl. No.: 18/459,610

(22) Filed: Sep. 1, 2023

Related U.S. Application Data
(60) Provisional application No. 63/403,072, filed on Sep. 1, 2022.

(51) Int. Cl. C25B 15/021; C25B 1/04; C25B 9/67; C25B 15/08

(52) U.S. Cl. CPC C25B 15/021; C25B 1/04; C25B 9/67; C25B 15/08; C25B 15/083

(57) ABSTRACT

The disclosure relates to an electrolysis system and method. The electrolysis system comprises a heating device for heating water above its boiling point (such as steam generator or flash desalinator) to produce a processed water product (such as steam or desalinated water). It also includes an electrolyzer that receives the processed water product to produce hydrogen gas and oxygen based on the processed water product. The system also includes a compressor that receives hydrogen gas and compresses the hydrogen gas, the compressor heating the hydrogen gas to a heated gas temperature; and a cooling system that cools the hydrogen gas from the heated gas temperature to a cooled temperature. The system also includes a heat transfer system that transfers absorbed heat from the cooling system to the heating device, the heating device producing the processed water product at least in part using the absorbed heat.

### CROSS-REFERENCE TO RELATED APPLICATIONS

This application claims priority to and the benefit of U.S. Provisional Patent Application No. 63/403,072, filed on Sep. 1, 2022 which is hereby incorporated by reference in its entirety.

### BACKGROUND

Hydrogen gas is often generated through electrolysis. During electrolysis, water molecules are broken down into hydrogen gas and oxygen gas. Electrolysis may occur using various mechanisms. For example, many electrolysis systems utilize one or more of proton exchange electrolysis, alkaline electrolysis, or solid-oxide electrolysis.

Once generated the hydrogen is generally compressed for storage or pipelines or for further use in another process, such as the Haber-Bosch process for ammonia production relying on steam methane reforming (SMR) and water gas shift (WGS). For instance, vehicle applications hydrogen is typically compressed to 350 or 700 bar.

### SUMMARY OF THE DESCRIPTION

In some aspects, the techniques described herein relate to a steam electrolysis system. The steam electrolysis system includes a heating device for heating water above its boiling point and to provide a processed water product. An electrolyzer receives the steam to produce hydrogen gas and oxygen based on the processed water product. A compressor receives hydrogen gas and compresses the hydrogen gas. The compressor heats the hydrogen gas to a heated gas temperature. A cooling system that cools the hydrogen gas from the heated gas temperature to a cooled temperature. A heat transfer system transfers absorbed heat from the cooling system to the steam generation device. The steam generation device produces steam at least in part using the absorbed heat.

In some aspects, the techniques described herein relate to a method for electrolysis. The method includes compressing hydrogen gas to a heated gas temperature in a compression system. The method includes cooling the compressed hydrogen gas to a cooled temperature in a cooling system. The cooled temperature is greater than a boiling point of water at atmospheric pressure. Cooling the compressed hydrogen gas includes absorbing absorbed heat from the compressed hydrogen gas. Using the absorbed heat, steam is generated. Using the steam, electrolysis is performed to produce electrolyzed hydrogen gas and oxygen gas.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

FIG. 1 is a system diagram of an ammonia production system, according to at least one embodiment of the present disclosure.

FIG. 2 is a flowchart of a method of ammonia production, according to at least one embodiment of the present disclosure.

FIG. 3-1 is a system diagram of an ammonia production system with a shared thermal storage device, according to at least one embodiment of the present disclosure.

FIG. 3-2 is a schematic diagram of an ammonia production system with dedicated thermal storage devices, according to at least one embodiment of the present disclosure.

FIG. 4 is a schematic diagram of thermal storage device, according to at least one embodiment of the present disclosure.

FIG. 5 is a schematic diagram of condenser and separator in an ammonia production system, according to at least one embodiment of the present disclosure.

FIG. 6 is a schematic diagram of a compression train in an ammonia production system, according to at least one embodiment of the present disclosure.

FIG. 7 is a system diagram of a steam electrolysis system, according to at least one embodiment of the present disclosure.

FIG. 8 is a system diagram of a compression and cooling system, according to at least one embodiment of the present disclosure.

FIG. 9 is a system diagram of a multi-stage compression and cooling system, according to at least one embodiment of the present disclosure.

FIG. 10 is a representation of a temperature and compression chart, according to at least one embodiment of the present disclosure.

FIG. 11 is a system diagram of a cooling system, according to at least one embodiment of the present disclosure.

FIG. 12 is a system diagram of a cooling system, according to at least one embodiment of the present disclosure.

FIG. 13 is a system diagram of a cooling system, according to at least one embodiment of the present disclosure.

FIG. 14 is a system diagram of a cooling system, according to at least one embodiment of the present disclosure.

### DETAILED DESCRIPTION

Embodiments of the present disclosure relate to methods for producing ammonia through a Haber-Bosch reaction. More particularly, some embodiments relate to ammonia production using energy recapture through both electricity and heat recapture. More particularly still, some embodiments relate to electricity and heat recapture and recycling from a hydrogen combustor to one or more stages of the ammonia production process. For example, a hydrogen combustor can combust a portion of the available hydrogen in combination with air to produce heat, electricity, and a nitrogen feedstock. The heat and electricity from the nitrogen feedstock production can be recycled back to a renewable energy source or to a solid-oxide electrolysis cell (SOEC) to produce energy or reduce energy consumption. The combustion of hydrogen in the presence of air produces water. In some embodiments, the water is further recycled from the combustion exhaust to a steam generator to be electrolyzed in the SOEC.

In some embodiments, an ammonia production system reacts hydrogen feedstock (e.g., H₂) with a nitrogen feedstock (e.g., N₂) to produce ammonia (NH₃) in a reactor at an elevated temperature. For example, the reaction may be conducted at pressures above 10 MPa (100 bar; 1,450 psi) and between 400 and 500° C. (752 and 932° F.). In some examples, the reaction may be conducted at pressures as low as 100 psi. In some embodiments, the gases (nitrogen and hydrogen) are passed over beds of catalyst, with cooling between each pass for maintaining a reasonable equilibrium constant. In some examples, a partial conversion is achieved on each pass (e.g., about 15% conversion), but any unreacted gases are recycled through the reactor, and eventually an overall conversion of 97% of feedstock gases can be achieved. In some embodiments, the catalyst consists of iron bound to an iron oxide carrier containing promoters such as aluminium oxide, potassium oxide, calcium oxide, potassium hydroxide, molybdenum, magnesium oxide, other materials, or combinations thereof.

Producing the feedstock gases for the reaction conventionally requires an external power source and can consume large amounts of electricity. Some embodiments of ammonia production systems, according to the present disclosure, can capture and recycle heat and electricity from within the system to reduce energy consumption. Some embodiments of ammonia production systems, according to the present disclosure, can include variable renewable energy (VRE) sources or imported off-peak electricity to further reduce carbon by-products of the system. In some embodiments, electricity and/or heat from the system is recycled to the VRE sources to further reduce energy consumption of the system.

In a conventional ammonia production system, nitrogen feedstock gas is produced through either membrane separation of pressure swing adsorption, both of which consume electricity to produce the nitrogen feedstock. In some embodiments, according to the present disclosure, a hydrogen combustor is used to combust hydrogen gas in the presence of air to produce a nitrogen/water mix from which a nitrogen feedstock is derived in an exothermic reaction. In some examples, heat from the exothermic reaction is recycled to vaporize water (in preparation for steam electrolysis). In some examples, the exothermic reaction can drive a turbine or internal combustion engine to produce electricity, which is used to power the electrolysis of the water. The heat and electricity by-products of the hydrogen combustion can, thereby, offset at least a portion of the energy consumed during production of the hydrogen feedstock. Water can also be recovered from the combustion exhausted and fed into the steam generator.

In other examples, heat from the hydrogen combustor can be recycled to the ammonia reactor (i.e., the Haber-Bosch reactor) to produce the elevated temperatures for the Haber-Bosch reaction. In yet other examples, heat from the hydrogen combustor can be recycled to a VRE source, such as a low-temperature (e.g., 90° C. or less) solar thermal generator to assist in producing electricity for the ammonia production system. In yet further examples, waste heat from the Haber-Bosch reaction can be recycled to vaporize water for electrolysis and/or for electricity production in a VRE source.

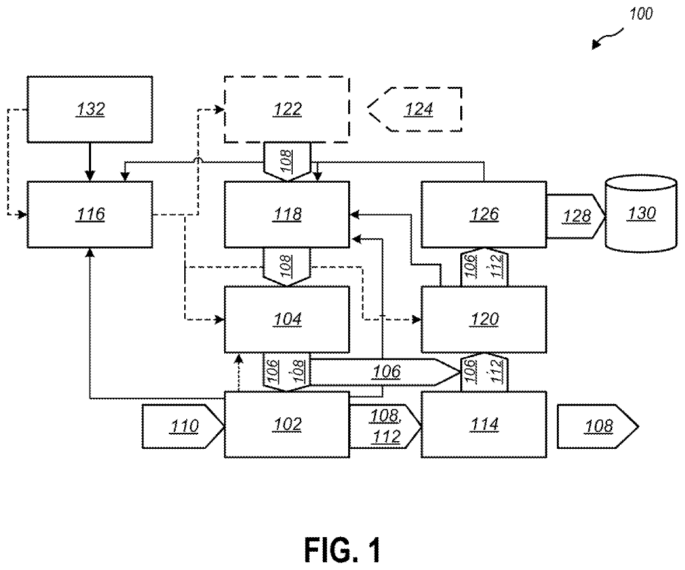

FIG. 1 is a system diagram illustrating an embodiment of an ammonia production system 100 according to the present disclosure. FIG. 1 also illustrates an embodiment of mass flow (block arrows), heat flow (solid arrows), and electricity flow (dashed arrows) in an ammonia production system 100 that captures and recycles energy to reduce cost and reduce energy consumption from external sources. The ammonia production system 100 includes a hydrogen combustor 102. A solid-oxide electrolysis cell (SOEC), 104 provides hydrogen (H₂) feedstock 106 and water vapor (H₂O) to the hydrogen combustor 102. The hydrogen combustor 102 combusts at least a portion of the hydrogen feedstock 106 with air 110 in an exothermic reaction to produce heat and electricity. The combustion results in products including nitrogen feedstock 112 that is exhausted with water 108 to a condenser 114. In some embodiments, the condenser 114 condenses and removes at least a portion of the water 108 from the input gases (e.g., the nitrogen feedstock 112 and water 108). The water 108 condensed by the condenser 114 may be recycled elsewhere in the ammonia production system 100 such as back to the steam generator 118.

While embodiments of the present disclosure discuss the electrolysis of water using an SOEC that produce hydrogen from steam and is therefore generally coupled with a steam generation device, it should be understood that electrolysis may occur using any type of electrolysis system, including high-temperature electrolysis systems, low-temperature electrolysis systems, high-pressure electrolysis systems, low-pressure electrolysis systems, and combinations thereof. Some of the electrolysis system above produce hydrogen from liquid water and such system may therefore not include a steam generation device. Examples of electrolysis systems include a Hofmann voltameter, alkaline water electrolysis, a proton exchange membrane, supercritical water, nickel/iron electrolysis, nanogap electrochemical cells, a capillary fed electrolyzer cell, proton exchange membrane (PEM) electrolysis, any other electrolysis system, and combinations thereof. In some embodiments, as discussed herein, electrolysis may be performed using water purified with a desalination system.

In some embodiments, the hydrogen combustor 102 includes a turbine generator that converts an expansion of the combustion reaction into electricity through the rotation of a shaft coupled to the turbine(s). In some embodiments, the hydrogen combustor 102 includes an internal combustion generator that converts an expansion of the combustion reaction within one or more cylinders into electricity through the rotation of a shaft coupled to a piston moveable within the cylinder(s). The hydrogen combustor 102 may convert the expansion of the gases during the combustion reaction into electricity in any relevant manner.

The heat produced by the hydrogen combustor 102, in some embodiments, is provided to one or more of a thermal power generation cycle 116, a steam generator 118, or other components of the ammonia production system 100. The heat from the hydrogen combustor 102 is provided to the thermal power generation cycle 116, steam generator 118, or other component to reduce the amount of energy consumed to heat the respective components. For example, a steam generator 118 may use resistive heating that consumes electricity to heat one or more heating elements through a resistance in the heating element, which dissipates at least a portion of the electrical power as heat. Resistive heating can consume a large amount of electricity. Using waste heat from other components of the ammonia production system 100, such as the hydrogen combustor 102, can reduce and/or eliminate the electricity consumption of the steam generator 118.

In other examples, a thermal power generation cycle 116 may use heat to generate electricity, allowing waste heat from the hydrogen combustor 102 and/or other components of the ammonia production system 100 to be converted into electricity. For example, the electricity produced by the thermal power generation cycle 116 may be provided to the SOEC 104.

In some embodiments, electricity is further provided to a compression train 120 that compresses one or more feedstock gases (e.g., hydrogen feedstock 106 and nitrogen feedstock 112). In FIG. 1, the feedstock gases are illustrated in a single mass flow from the SOEC 104 and the condenser 114, and the feedstock gases may be compressed in the compression train 120 together in a shared volume. In some embodiments, the feedstock gases may be compressed in separate compression trains 120. For example, the compressibility of the feedstock gases may be different, and different quantity of compression steps or different compression ratios at each compression steps may be different for the different feedstock gases. As will be described herein, in some embodiments, a compression train 120, according to the present disclosure, may maintain a temperature of the feedstock gases above a selected temperature to allow recycling of heat from the compressor(s) of the compression train 120 to the steam generator 118 or other components of the ammonia production system 100.

In some embodiments, the SOEC 104 produces hydrogen feedstock 106 from water 108 that is supplied by a steam generator 118. The steam generator 118 heats the water 108 above the boiling temperature to produce steam that is provided to the SOEC 104. In some embodiments, the steam generator 118 includes resistive heating elements to heat the water. In some embodiments, the steam generator 118 heats the water with a heat pump. In some embodiments, the steam generator 118 consumes less energy than a conventional ammonia production system by recycling at least a portion of the heat produced elsewhere in the ammonia production system 100 to heat and/or vaporize the water.

In some embodiments, the ammonia production system 100 further includes a desalination device 122. For example, the desalination device 122 may receive input water 124 from a saline source, such as ocean water, and desalinate the water for use in the ammonia production system 100. In some embodiments, such as illustrated in FIG. 1, the desalination device 122 provides water 108 to the steam generator 118 to produce steam that is more easily electrolyzed by the SOEC 104. In some embodiments, desalinated water is used to fill an energy storage system, provided a coolant in heat exchange cycles, provide water to the thermal power generation cycle 116, provide water to the steam generator 118, or combinations thereof. Desalination to the target requirement of SOEC's has a significant energy requirement that can be delivered by a VRE source 132, from the thermal power generation cycle 116, through a Reverse Osmosis (RO) process, through supplemental heat recycled from other components of the ammonia production system 100, or combinations thereof. Thermal desalination may be performed using a flash desalination process (ie heating water past its boiling point) or any other suitable process known from the one of ordinary skill. Thermal desalination is, therefore, an opportunity to recycle heat from thermal storage or other components of the ammonia production system 100 to provide at least a portion of the required energy load for desalination.

For example, there are 2 methods that can be integrated into a combined progress, which each provide additional energy efficiency through the use of either heat or electricity. The specific VRE source 132 may affect the amount of heat recycled to the desalination. In some examples, as the balance of generation from a concentrated solar thermal generator shifts toward more electricity, or more thermal capacity per square-meter of receiver area, a surplus of either may emerge. A future increase in photovoltaic efficiency may favor more electricity, driving the use of a more economical reverse osmosis (RO) processes. If the thermal tolerance of photovoltaic cells improves at a proportionally higher rate in the future, an increase in temperature and heat load may favor thermal (flash) desalination via evaporation.

After producing the hydrogen feedstock 106 and the nitrogen feedstock 112, an ammonia production system 100 may include an ammonia reactor 126 (such as a Haber-Bosch reactor) or other reactor to produce ammonia 128. The ammonia 128 may then be delivered to an ammonia storage device 130 for distribution, packaging, further treatment, or combination with other produces.

In some embodiments, the ammonia 128 is the final product of the ammonia production system 100. For example, the ammonia can be exported or combusted to generate energy on demand for the process or network electricity demand. In some embodiments, the ammonia production system 100 is part of a production system for another product, and the ammonia 128 is provided as a part of another product.

In some embodiments, according to the present disclosure, only the Haber-Bosch synthesis loop is required, with nitrogen feedstock 112 and hydrogen feedstock 106 fed by the SOEC 104 and hydrogen combustor 102 and the heating and compression train 120 powered by the VRE source 132.

The ammonia reactor 126, in some embodiments, produces heat that is recycled to other components of the ammonia production system 100. In some embodiments, an exothermic reaction across an iron-based catalyst bed creates a high temperature discharge stream from the reactor. This high temperature heat load at ˜500° C. discharged from the reactor is recycled into the working fluid in the thermal cycle, as superheat, with the residual heatload used for preheating the compressed feedstock (e.g., nitrogen feedstock 112 and hydrogen feedstock 106) stream from the compression train 120 to the ammonia reactor 126. Further cooling requirements for the nitrogen feedstock 112, hydrogen feedstock 106, and ammonia 128 stream(s) are provided by a low temperature chiller, with the rejected heat returned to the hot storage. The thermal storage system further improves the exchange efficiency.

In some embodiments, ammonia is separated through a multistage separator in or after the ammonia reactor 126, which allows nitrogen feedstock 112 and hydrogen feedstock 106 to be recycled back into the compression train 120, for reprocessing. The typical single pass Haber-Bosch reactor yield is between 12 and 18%. Further development of catalysts and electrolytic cells may improve the yield value further. Further advances in both conversion options provide further efficiency to drive down the levelized cost of ammonia according to the present disclosure. The utilization of the exothermic heat recycled back into the thermal power generation cycle 116 and other components of the ammonia production system 100 to boost efficiency of the ammonia production system 100 allows less energy consumption and lower cost of operations compared to a conventional Haber-Bosch synthesis loop production system.

In some embodiments, heat is recycled from a heat source component to a heat sink component in the ammonia production system 100 directly through a thermal conduit. A heat source component is any component of the ammonia production system 100 that produces heat and/or has heat produced therein during operation, such as by an exothermic reaction or electrical conversion, such as an alternating current (AC) to direct current (DC) convertor. For example, a heat source component includes the hydrogen combustor 102, the compression train 120, the ammonia reactor 126, and the VRE source 132. A heat sink component is any component of the ammonia production system that receives heat or consumes heat during operation. For example, a heat sink component includes the steam generator, the thermal energy generation cycle 116, and the desalination device 122. In some examples, a component may selectively be a heat source component and/or a heat sink component, such as the ammonia reactor 126 which can be heated prior to a Haber-Bosch cycle but also produces heat through the exothermic reaction. In some embodiments, the ammonia reactor 126 can receive heat to preheat the ammonia reactor 126 and then export heat after the exothermic reaction.

In some embodiments, the heat is transferred from a heat source component to a heat sink component through a thermal conduit that conducts heat and/or transfers heat through a mass flow. For example, some thermal conduits may be a solid-state thermal conduit that conduct heat through thermally conductive solid mass, such as a rod or sheet between the heat source component and the heat sink component. In some examples, the thermal conduit is a solid copper conduit. In other examples, some thermal conduits may be a fluid-based conduit that flows a working fluid through and/or in at least a portion of the conduit to move heat from the heat source component and the heat sink component. For example, the working fluid may be water. In other examples, particularly those transferring heat from a heat source component with a temperature above the boiling temperature of water, the working fluid may be a different working fluid with a higher boiling temperature to allow the working fluid to remain liquid while transferring heat. In yet other examples, the working fluid may be a multi-phase working fluid that changes physical state during the heat transfer process. As the latent heat of boiling allows the working fluid to receive additional heat without an associated increase in temperature, a multi-phase working fluid can further increase the heat transfer efficiency of a thermal conduit.

In some embodiments, one or more of the thermal conduits that move heat from a heat source component to a heat sink component is a dedicated conduit. For example, the thermal conduit is configured to move heat only from a heat source component to a heat sink component. In some embodiments, one or more of the thermal conduits that move heat from a heat source component to a heat sink component is a shared conduit. For example, the thermal conduit is configured to transfer heat from a plurality of heat source components to a single heat sink component, from a single heat source component to a plurality of heat sink components, or from a plurality of heat source components to a plurality of heat sink components.

In some embodiments, heat is recycled from a heat source component to a heat sink component in the ammonia production system 100 indirectly through a thermal storage device. For example, a thermal storage device may be positioned in or along any of the thermal conduits (e.g., illustrated as heat transfer lines illustrated in FIG. 1) that receives heat from a heat source component and stores the heat for subsequent transfer to a heat sink component. In some embodiments, one or more thermal storage devices are dedicated thermal storage devices. For example, the dedicated thermal storage device is positioned in or along a dedicated thermal conduit. In some embodiments, one or more thermal storage devices are shared thermal storage devices. For example, the shared thermal storage device is positioned in or along a shared thermal conduit.

One or more electrical conduits, in some embodiments, are configured to provide electrical communication between an electrical source component and an electrical sink component. In some embodiments, one or more of the electrical conduits that move electricity from an electrical source component to an electrical sink component is a dedicated conduit. For example, the electrical conduit is configured to provide electricity only from an electrical source component to an electrical sink component. In some embodiments, one or more of the electrical conduits that conduct electricity from the electrical source component to the electrical sink component is a shared electrical conduit. For example, the electrical conduit is configured to transfer electricity from a plurality of electrical source components to a single electrical sink component, from a single electrical source component to a plurality of electrical sink components, or from a plurality of electrical source components to a plurality of electrical sink components.

In some embodiments, electricity is recycled from an electrical source component to an electrical sink component in the ammonia production system 100 indirectly through an electrical storage device (e.g., a battery, a capacitor, other electrical storage devices, or combinations thereof). For example, an electrical storage device may be positioned in or along any of the electrical conduits (e.g., illustrated as electrical transfer lines illustrated in FIG. 1) that receives electricity from an electrical source component and stores the electricity for subsequent transfer to an electrical sink component. In some embodiments, one or more electrical storage devices are dedicated electrical storage devices. For example, the dedicated electrical storage device is positioned in or along a dedicated electrical conduit. In some embodiments, one or more electrical storage devices are shared electrical storage devices. For example, the shared electrical storage device is positioned in or along a shared electrical conduit.

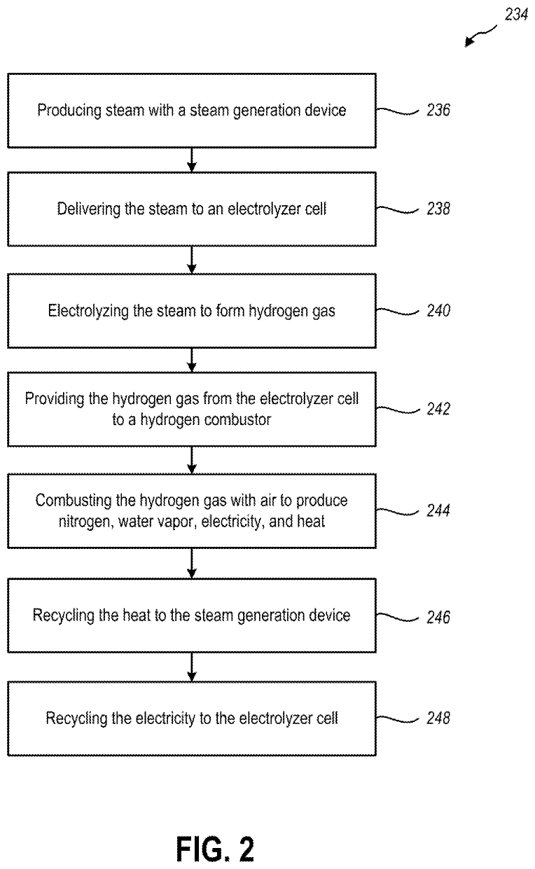

FIG. 2 is a flowchart of an embodiment of a method 234 of ammonia production. In some embodiments, the method 234 includes producing steam with a steam generating device at 236 and delivering the steam to an electrolyzer cell at 238. In some embodiments, the electrolyzer cell is a SOEC such as described in relation to FIG. 1. The method further includes electrolyzing the steam to form hydrogen gas at 240. In some embodiments, the steam is not fully converted into hydrogen gas and oxygen gas, and at least a portion of the water remains in the electrolyzer cell. The unreacted water may be removed when the other gases are removed from the electrolyzer cell, or the unreacted water may remain in or be recycled back into the electrolyzer cell for further processing.

The method 234 further includes providing the hydrogen gas from the electrolyzer cell to a hydrogen combustor at 242 and combusting the hydrogen gas with air to produce nitrogen, water vapor, electricity, and heat at 244. In some embodiments, providing the hydrogen gas to the hydrogen combustor includes dividing the hydrogen gas produced in the electrolyzer cell into a first stream directed to the hydrogen combustor and a second stream directed to a compression train. For example, the first stream of hydrogen gas to the hydrogen combustor may include approximately 50% of the hydrogen gas produced by the electrolyzer cell, while the second stream of hydrogen gas to the compression train includes the remaining approximately 50% of the hydrogen gas. In other examples, the first stream of hydrogen gas to the hydrogen combustor may include less than 50%, such as approximately 15% of the hydrogen gas produced by the electrolyzer cell, while the second stream of hydrogen gas to the compression train includes the remaining hydrogen gas, such as approximately 85% of the hydrogen gas. In yet other examples, the first stream of hydrogen gas to the hydrogen combustor may include greater than 50%, such as approximately 70% of the hydrogen gas produced by the electrolyzer cell, while the second stream of hydrogen gas to the compression train includes the remaining hydrogen gas, such as approximately 30% of the hydrogen gas.

In some embodiments, combusting the hydrogen gas with air occurs in a hydrogen combustor including or coupled to an electrical generator that converts an expansion caused by the combustion into electricity. In some examples, the electrical generator converts the expansion into electricity through the expansion rotating a turbine. In some examples, the electrical generator converts the expansion into electricity through the expansion moving pistons that rotate a shaft. The rotation of the turbine and/or shaft can be converted to electricity to produce the electricity.

After the nitrogen, water vapor, electricity, and heat are produced at 244, the method 234 includes recycling at least a portion of the heat to the steam generation device at 246 and recycling at least a portion of the electricity to the electrolyzer cell at 248. In some embodiments, recycling the heat to the steam generation device includes transferring the heat through a combustion thermal conduit from the hydrogen combustor to the steam generation device. For example, the combustion thermal conduit may be a dedicated conduit. In other examples, the combustion thermal conduit may be a shared conduit that receives heat from the hydrogen combustor. In yet other examples, the combustion thermal conduit may be a shared thermal conduit that provides heat to the steam generator from at least the hydrogen combustor. In some embodiments, the combustion thermal conduit includes a thermal storage device in or along the combustion thermal conduit that allows heat to be transferred from the hydrogen combustor to the thermal storage device. The thermal storage device may store the heat from the hydrogen combustor for at least some period of time before releasing the heat to the steam generator device.

In some embodiments, recycling at least a portion of the electricity to the electrolyzer cell at 248 includes transferring the heat through a combustion electrical conduit from the hydrogen combustor (and/or the electrical generator associated therewith) to the electrolyzer cell. For example, the combustion electrical conduit may be a dedicated electrical conduit. In other examples, the combustion electrical conduit may be a shared electrical conduit that receives electricity from the hydrogen combustor and/or electrical generator. In yet other examples, the combustion electrical conduit may be a shared electrical conduit that provides electricity to the electrolyzer cell from at least the hydrogen combustor and/or electrical generator. In some embodiments, the combustion electrical conduit includes an electrical storage device in or along the combustion electrical conduit that allows electricity to be transferred from the hydrogen combustor and/or electrical generator to the electrical storage device. The electrical storage device may store the electricity from the hydrogen combustor and/or electrical generator for at least some period of time before releasing the electricity to the electrolyzer cell.

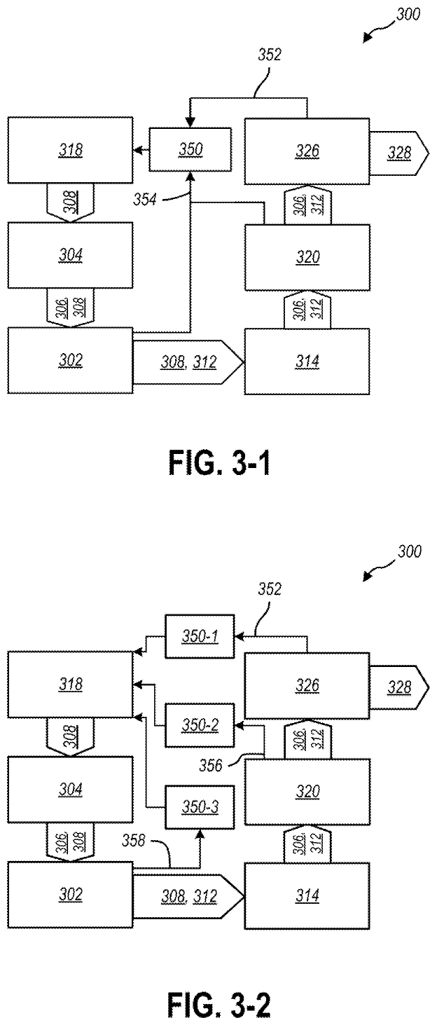

In some embodiments, the thermal storage device receives heat from a plurality of heat source components, such as illustrated in FIG. 3-1. FIG. 3-1 illustrates an embodiment of a portion of an ammonia production system 300 with a shared thermal storage device 350 that receives heat from a reactor thermal conduit 352 and a shared conduit 354 that provides heat from the hydrogen combustor 302 and the compression train 320. The thermal storage device 350 can store the heat and selective transfer the heat to the steam generation device 318 to heat the steam generation device 318 and reduce and/or eliminate energy consumption by the steam generation device 318. The steam generation device 318 can then provide the steam (e.g., water 308) to the SOEC 304, which provides the hydrogen feedstock 306 to the hydrogen combustor 302. The resulting nitrogen feedstock 312 is provided to the condenser 314 and/or the compression train 320 which compress the feedstock gases before the ammonia reactor 326 that produces the ammonia 328.

In some embodiments, a plurality of thermal storage devices receives and distribute heat through the ammonia production system, allowing heat flow to be managed in response to demand, such as illustrated in FIG. 3-2. In FIG. 3-2, the illustrated embodiment includes a first thermal storage device 350-1 configured to receive heat from the reactor thermal conduit 352, a second thermal storage device 350-2 configured to receive heat from the compressor thermal conduit 356, and a third thermal storage device 350-3 configured to receive heat from the combustion thermal conduit 358. Each dedicated thermal storage device 350-1, 350-2, 350-3 can selectively provide heat to the steam generation device 318 independently. In the illustrated embodiment, the thermal conduits transferring heat from the thermal storage devices 350-1, 350-2, 350-3 and to the thermal storage devices 350-1, 350-2, 350-3 are each dedicated thermal conduits.

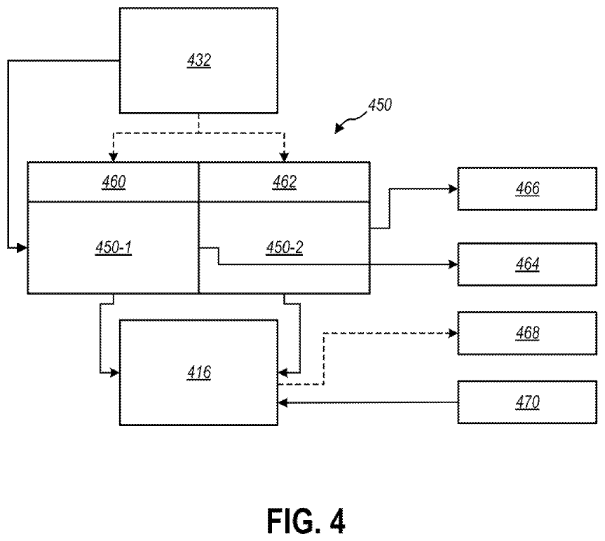

FIG. 4 is a detail flowchart illustrating an embodiment of a thermal storage device 450 and management in relation to a thermal energy generation cycle 416, such as thermal energy generation cycle 116 of FIG. 1. In some embodiments, a thermal storage device 450 of the ammonia production system includes both a high temperature thermal storage device 450-1 and a low temperature thermal storage device 450-2. For example, the low temperature thermal storage device 450-2 may be cooled through a chiller 462, utilizing the energy generation from either the solar thermal generator, photovoltaic panels, wind, or other VRE Source 432, or imported off-peak electricity. Storage as chilled water, ice slurry, solid storage, or a phase change materials allows the recovery of the stored energy (i.e., heat sink) on demand.

In removing heat from the chilled fluid, the reject heat can be recovered through a heat pump 460 or other heat exchange mechanism and also delivered to the high temperature thermal storage device 450-1, as illustrated in FIG. 4. Stored heat can be directly exported to heat sink components 464 such as desalination, steam generation, SOEC heating, and reactor pre-heating. Stored chilled solid/fluid/gas can be exported and applied directly in thermal management components 466 within the ammonia production system, such as cooling, condensing, and compression applications.

The thermal energy generation cycle 416, in some embodiments, produces electricity to power one or more electrical loads 468 in the ammonia production system by converting imported heat 470 from the high temperature thermal storage device 450-1, from other heat source components in the ammonia production system, or from VRE sources 432 such as a solar thermal generator. For example, the thermal energy generation cycle 416 may be a low-temperature thermal energy generation cycle (e.g., a Rankine cycle) that operates with an operating temperature of no more than 100° C. In some embodiments, a low temperature thermal energy generation cycle allows for electricity to be generated from recycled heat. The thermal energy generation cycle 416, in some embodiments, produces electricity based on a temperature difference between a hot portion heated, at least partially, by the imported heat 470 (such as from the high temperature thermal storage device 450-1) and a cold portion chilled by, at least partially, the low temperature thermal storage device 450-2. The thermal storage device(s) may, thereby, allow selective distribution of high or low temperatures to adjust electricity production.

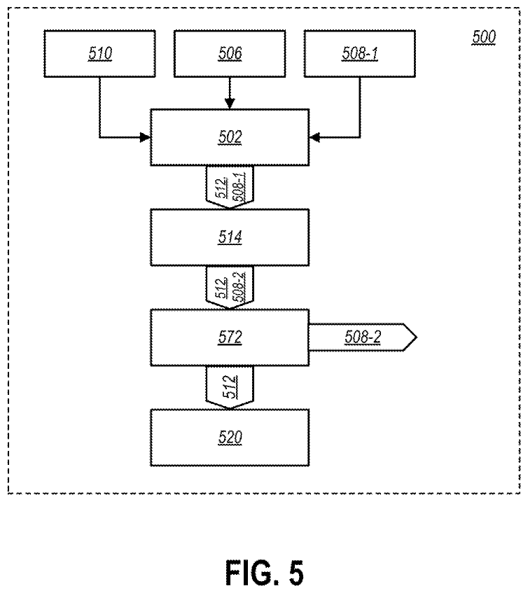

FIG. 5 is a system diagram of an embodiment of part of an ammonia production system 500 with a condenser 514 configured to condense vapor phase water 508-1 into liquid phase water 508-2 and a separator 572 to recycle liquid phase water 508-2 to one or more components of the ammonia production system 500. In some embodiments, air 510, hydrogen feedstock 506, and vapor phase water 508-1 are provided to the hydrogen combustor 502. For example, the hydrogen feedstock 506 and the vapor phase water 508-1 may be provided by the SOEC, such as described herein. The hydrogen combustor 502 combusts the hydrogen feedstock 506 with the air 510 to produce a nitrogen feedstock 512. The vapor phase water 508-1 remains in the stream and continues with the nitrogen feedstock 512 to the condenser 514.

In some embodiments, the condenser 514 cools the stream of nitrogen feedstock 512 and vapor phase water 508-1 below the boiling temperature of the water (e.g., 100° C. or other boiling temperature relative to a pressure in the condenser), and the condenser 514 passes the nitrogen feedstock 512 and the liquid phase water 508-2 to a separator 572. In some embodiments, the separator 572 is integrated with the condenser 514 in a single component. The separator 572 separates the liquid phase water 508-2 from the nitrogen feedstock 512 and passes the nitrogen feedstock 512 to the compression train 520 while directing the liquid phase water 508-2 to be recycled to other components and/or storage devices in the ammonia production system 500, such as the desalination device, the electrolyzer cell, the thermal energy generation cycle, and thermal management devices, via a water conduit such as a pipe.

In some embodiments, the combustion products (e.g., water and contaminants) remaining after combustion are returned to the steam generator, recycling at least a portion of the combustion heat. In some embodiments, the condenser 514 is integrated with a steam generation device heat exchanger. Additional cooling may be provided by a low-temperature thermal storage device. The separator 572 may be further integrated with the condenser 514 and the steam generator for the efficient separation of gaseous nitrogen feedstock 512 from the water in the combustion stream.

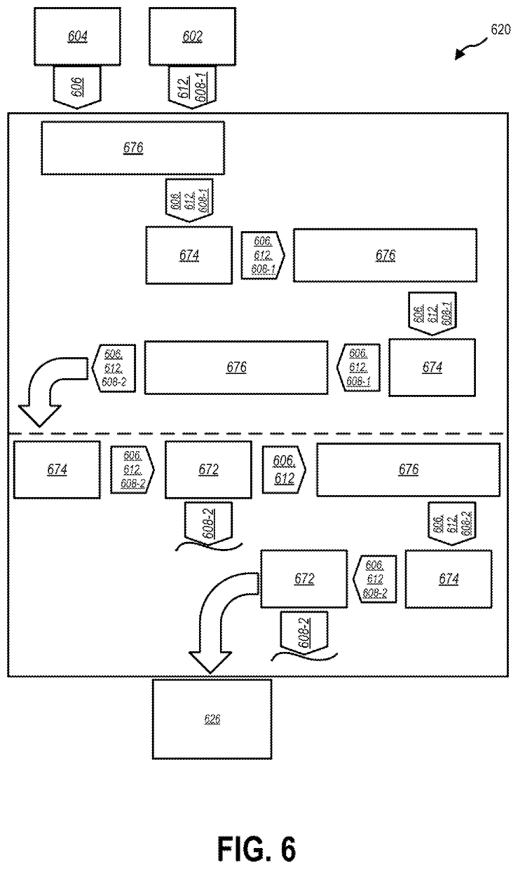

FIG. 6 is a detail flowchart of an embodiment of a compression train 620 including separators 672 to separate liquid phase water 608-2 from the feedstock gases (e.g., hydrogen feedstock 606 and nitrogen feedstock 612). In some embodiments, the compression train 620 receives hydrogen feedstock 606 from the electrolyzer cell 604 and nitrogen feedstock 612. The Haber-Bosch ammonia synthesis cycle conventionally uses a catalyzed reaction of hydrogen feedstock 606 and nitrogen feedstock 612 over a catalyst at high pressures (e.g., 2500-3500 pounds per square inch) and high temperatures (e.g., 300-500° C.). To produce the high-pressure hydrogen feedstock 606 and nitrogen feedstock 612 stream at the inlet of the catalyst contactor, a compression train 620 is, in some embodiments, used to compress the gases with an associated adiabatic compression heat produced as a byproduct. The heatload generated by increasing the pressure of this gas stream (combined or separate), is comparable to steam energy requirement for the electrolyzer cell process, and at least a portion of the compression heat can be transferred to the steam generator to recycle the heat.

Conventionally, a compression train would be optimized for the lowest quantity of cycles to reach the pressure require. In some embodiments, according to the present disclosure, a compression train 620 has five or more cycles to keep the minimum temperature consistent in each cycle and produce a heatload from each cycle that can be used for steam generation. In some embodiments, the heatload remains above 105° C. at one or more compressors 676 and/or coolers 674 in the compression train 620. In some embodiments, the heatload remains above 105° C. at all compressors 676 and/or coolers 674 in the compression train 620. In some embodiments, the ammonia production system includes one or more cooler thermal conduits to provide thermal transfer (e.g., transfer heat) from the cooler(s) 674 to the steam generation device. In some embodiments, the ammonia production system includes one or more cooler thermal conduits to recycle the compression heat by transferring compression heat from the cooler(s) 674 to a thermal storage device.

In some embodiments, the compression train 620 includes a series of compressors 676 and coolers 674 to serially compress the feedstock stream (which produces an associated adiabatic compression heat) and cool the feedstock stream as it heats during compression. In some embodiments, the input stream (e.g., from the hydrogen combustor 602) includes vapor phase water 608-1. The vapor phase water 608-1 is compressed and cooled through the compression train until the compression exceeds the vapor pressure of water at the temperature of the water. For example, in embodiments where the temperature of the stream remains above 105° C. throughout the compression train, the water will remain above the boiling temperature of water at atmosphere, but the compression train 620 may, at some point, compress the vapor phase water 608-1 past the vapor pressure of the water at (or above) 105° C., and the vapor phase water 608-1 will condense into a liquid phase water 608-2. After compressing the water past the vapor pressure, the liquid phase water 608-2 is, in some embodiments, removed from the feedstock stream through one or more separators 672. With each compression at a compressor 676, additional water may condense out and be removed with a separator 672. The compressed nitrogen feedstock 612 and hydrogen feedstock 606 is, in some embodiments, provided to the ammonia reactor 626 for ammonia production.

In some embodiments, the minimum temperature of the stream in the compression train 620 (or at one or more compressors 676 and/or coolers 674 in the compression train 620) is greater than 105° C. For example, the minimum temperature may be 110° C., 115° C., 120° C., 130° C. or another temperature that is greater than a boiling temperature of the water in the electrolyzer cell. In at least one example, the electrolyzer cell may be configured to operate at an elevated pressure, and the boiling temperature of water at the elevated pressure may be 130° C. A minimum temperature of the stream in the compression train 620 greater than the boiling temperature of water at the elevated pressure may ensure the compression heat recycled to the electrolyzer cell heats the electrolyzer cell above the boiling temperature of the water being electrolyzed.

The compression train 620 described herein is not the most efficient for compression, as the compression train 620 maintains the temperature of some or all of the compression cycles to 105° C. or more. However, maintaining the temperature above a threshold value with a greater quantity of compression cycles, in some embodiments, allows the reject heatload to be recovered and used directly for steam generation, without additional electrical heating equipment and cooling tower to discharge waste heat. Any additional heatload, not required at the electrolyzer cell or steam generator can be directed to the energy storage in the thermal system, and stored for later use, either as heat in a thermal storage device or electricity in an electrical storage device.

In at least some embodiments of the present disclosure, an ammonia production system, or subsystems thereof, uses a hydrogen combustor to produce nitrogen feedstock gas for ammonia production. The ammonia production system, or subsystems thereof, recycles at least a portion of produced heat and electricity to reduce the overall energy consumption and carbon usage of the ammonia production system.

In accordance with at least one embodiment of the present disclosure, a steam electrolysis system may transfer heat from the compression stage to the steam generator. During compression, as discussed herein, the cooling system may cool the compressed gasses (e.g., hydrogen gas and/or nitrogen gas) to a temperature above the boiling point of water. The absorbed heat may be transferred to the steam generator for the steam electrolysis system. Because the absorbed heat is above the boiling point of water, the absorbed heat may be used to generate at least a portion of the steam used during electrolysis. This may help to improve the efficiency of the steam electrolysis system. For example, utilizing the absorbed heat to generate at least a portion of the steam may reduce the amount of electricity input into the steam generator. While embodiments of the present disclosure have discussed steam electrolysis with respect to the production of ammonia, it should be understood that the heat transfer system between the compressor and the steam generator, as discussed in further detail herein, may be used with any steam electrolysis system, including those not used for the production of ammonia.

In some embodiments, the steam electrolysis system may include a thermal store. Heat absorbed during compression of the gasses may be stored in the thermal store. The heat may then be used to generate steam from the steam generator. In this manner, the heat generated during gas compression may be stored for later use.

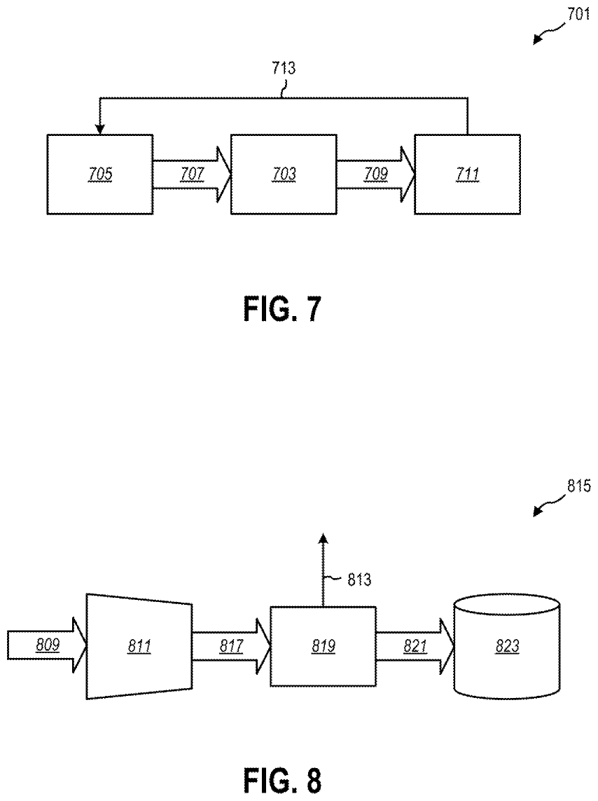

FIG. 7 is a representation of a steam electrolysis system 701, according to at least one embodiment of the present disclosure. The steam electrolysis system 701 includes a steam electrolyzer 703. The steam electrolyzer 703 may separate water into its component portions (e.g., hydrogen gas and oxygen gas). The steam electrolyzer 703 may be any type of electrolyzer. For example, the steam electrolyzer 703 may be a high-temperature electrolyzer, or an electrolyzer that operates at a relatively high temperature. In some embodiments, the steam electrolyzer 703 may be a steam (e.g., water vapor) electrolyzer, that splits steam into hydrogen gas and oxygen gas. In some embodiments, the steam electrolyzer 703 may include a solid-oxide electrolysis cell (SOEC). In some embodiments, the steam electrolyzer 703 may be any electrolyzer that performs electrolysis using steam or water vapor. The steam electrolyzer 703 may perform electrolysis with steam heated to an electrolysis temperature. The electrolysis temperature may include any electrolysis temperature, including 600° C., 700° C., 800° C., 900° C., 1,000° C., or any value therebetween.

A steam generator 705 may generate steam 707 and pass the steam 707 to the steam electrolyzer 703. The steam generator 705 may generate the steam 707 from any water source. For example, as discussed herein, the steam generator 705 may receive water to generate the steam 707 from one or more utilities, rivers, lakes, wells, and/or desalination plants. As will be discussed in further detail herein, the steam generator 705 may receive water to generate the steam 707 from one or more combustion processes by combusting the hydrogen and/or the oxygen generated by the steam electrolyzer 703.

The steam electrolyzer 703 may generate hydrogen gas 709. The hydrogen gas 709 may be passed to one or more compressors 711, to be further transported or stored and/or further processed. As may be understood, during compression of the hydrogen gas 709 by the compressors 711, the hydrogen gas 709 may generate heat. For example, heat may be generated based on the compression of the hydrogen gas, as may be understood based on the ideal gas law. The hydrogen gas may be compressed to a storage and/or transportation pressure.

To maintain the hydrogen gas below an operating temperature of the one or more compressors 711, a cooling system may cool the compressors and/or the hydrogen gas by absorbing the compression heat. The absorbed heat may be transferred to the steam generator 705 using a heat transfer system 713. The absorbed heat may be used to generate at least a portion of the steam 707. This may help to reduce the energy expended by the steam generator 705 to generate the steam 707. In some embodiments, this may help reduce and/or prevent the loss and/or waste of at least a portion of the heat generated by the compressors 711. Put another way, the heat transfer system 713 may recycle at least a portion of the heat generated at the compressors 711 through compression of the hydrogen gas 709.

While the present disclosure identifies that the compressors 711 compress hydrogen gas, it should be understood that the steam electrolysis system 701 may utilize heat generated from the compression of any gas. For example, the compressors 711 may compress oxygen produced by the steam electrolysis system. For example, the steam electrolysis system 701 may be part of an ammonia production system. In the ammonia production system, the compressors 711 may compress the nitrogen gas and/or the hydrogen gas used to produce the ammonia. In some embodiments, the compressors 711 may compress a mixture of nitrogen and hydrogen gas. In some embodiments, a nitrogen compressor 711 may compress nitrogen gas and a hydrogen compressor 711 may compress hydrogen gas, with the nitrogen gas and the hydrogen gas compressed separately.

In some embodiments, the cooling system may cool the compressed gasses to a cooled temperature. The cooled temperature may be the lowest temperature to which the cooling system cools the compressed gases and/or the compressors 711. The heat transfer system 713 may transfer the absorbed heat and re-use the heat to generate steam at the steam generator 705. The heat absorbed by the heat transfer system 713 may be used to heat input water at the steam generator 705 to approximately the cooled temperature (minus losses in the heat transfer system 713). For example, the heat transfer system 713 may include a heat transfer medium that may be heated to the cooled temperature. The heat transfer medium of the heat transfer system 713 may be applied to the input water at the steam generator 705, and the input water may absorb heat from the heat transfer medium. In some embodiments, the input water may be heated to approximately the temperature of the heat transfer medium (minus losses). In this manner, as discussed herein, the heat transferred from the compressors 711 through the heat transfer system 713 may be used to pre-heat the input water to approximately the cooled temperature of the compressors 711.

In accordance with at least one embodiment of the present disclosure, the heat transfer medium of the heat transfer system 713 may be any heat transfer medium. For example, the heat transfer medium may include a liquid. The liquid may have a boiling point that is greater than the cooling temperature. The liquid may be transferred through pipes in the heat transfer system 713 to the steam generator 705. In some examples, the heat transfer medium may include a gas that is transferred through pipes in the heat transfer system 713 to the steam generator 705. In some examples, the heat transfer medium may include a solid material. The solid material may absorb the heat and transfer it to the steam generator 705. For example, liquid input water may be flowed through a sleave or pipe formed from a solid heat transfer medium. This may cause the input water to evaporate, generating steam. In some embodiments, the heat transfer medium may include a phase-change material, such as a liquid-to-gas phase-change material or a solid-to-liquid phase-change material.

In some embodiments, the system may include a desalination device instead of a steam generator or in addition to steam generator. For example, the desalination device may receive input water from a source that needs polishing, such as ocean water or underground water, and desalinate the water for use in an electrolysis system. In some embodiments, if the electrolyzer is a low temperature electrolyzer, the electrolyzer produces a hydrogen feedstock from liquid water and the desalination device provides water to the electrolyzer. In some embodiments, the desalination device provides water to the steam generator to produce steam that is more easily electrolyzed. In some embodiments, desalinated water is used to fill an energy storage system, provide a coolant in heat exchange cycles, provide water to a thermal power generation cycle, provide water to the steam generator, or combinations thereof. In accordance with at least one embodiment of the present disclosure, the absorbed heat may be used to desalinate water and/or heat the desalinated water to the target requirement of SOEC. Thermal desalination is, therefore, an opportunity to recycle heat to provide at least a portion of the required energy load for desalination.

In some embodiments, the cooling system may cool the gasses and/or the compressors 711 to a cooled temperature that is greater than the boiling point of water. This may cause the heat transfer medium to be heated to greater than the boiling point of water. The heat transfer system 713 may cause the input water to boil. In this manner, at least a portion of the energy used to compress the gasses at the compressors 711 may be recycled (in the form of heat) and used to reduce the energy consumption at the steam generator 705 by reducing the energy used to increase the temperature of the input water to the steam generator 705. This may help to improve the overall efficiency of the steam electrolysis system 701.

FIG. 8 is a representation of a compression and cooling system 815, according to at least one embodiment of the present disclosure. The compression and cooling system 815 include a compressor 811. The compressor 811 may receive hydrogen gas 809 and compress it. While the embodiment of FIG. 8 is discussed with respect to hydrogen gas, it should be understood that the techniques described herein may be applied to any gas, such as hydrogen gas, oxygen gas, ammonia, atmospheric gas, any other gas, and combinations thereof. The compressed hydrogen gas 817 may have a heated gas temperature. The heated gas temperature may be the highest temperature at which the compressor 811 may operate. The compressed hydrogen gas 817 may be cooled in a cooling system 819. The cooling system 819 may absorb at least a portion of the heat from the compressed hydrogen gas 817. A heat transfer system 813 may transfer at least a portion of the absorbed heat away from the cooling system 819. For example, the heat transfer system 813 may transfer the absorbed heat to a steam generator in a steam electrolysis system.

In some embodiments, the heated gas temperature may be in a range having an upper value, a lower value, or upper and lower values including any of 135° C., 140° C., 150° C., 160° C., 170° C., 180° C., 190° C., 200° C., 210° C., 220° C., 230° C., 240° C., 250° C., or any value therebetween. For example, the heated gas temperature may be greater than 135° C. In another example, the heated gas temperature may be less than 250° C. In yet other examples, the heated gas temperature may be any value in a range between 135° C. and 250° C. In some embodiments, it may be critical that the heated gas temperature is greater than 170° C. to compress the hydrogen gas 809 to a sufficient pressure.

The cooling system 819 may cool the compressed hydrogen gas 817 to a cooled hydrogen gas 821. The cooled hydrogen gas 821 may be cooled to a cooled temperature. As discussed herein, the heat transfer system 813 may include a heat transfer media. The heat transfer media may be heated to approximately the cooled temperature of the cooled hydrogen gas 821. The heat transfer media may transfer the heat to another location, such as a thermal store and/or a steam generation system.

In some embodiments, the cooled temperature may be in a range having an upper value, a lower value, or upper and lower values including any of 100° C., 105° C., 110° C., 115° C., 120° C., 125° C., 130° C., or value therebetween. For example, the cooled temperature may be greater than 100° C. In another example, the cooled temperature may be less than 130° C. In yet other examples, the cooled temperature may be any value in a range between 100° C. and 130° C. In some embodiments, it may be critical that the cooled temperature is greater than 105° C. to allow the absorbed heat to boil the input water to the steam generator. In some embodiments, it may be critical that the cooled temperature is greater than or equal to the boiling temperature of water at atmospheric temperature to allow the absorbed heat to boil the input water to the steam generator. In some embodiments, it may be critical, to allow the cooling system to provide some cooling to the compressed gasses, that the cooled temperature is at least 10° C. cooler than the heated gas temperature.

When the cooled hydrogen gas 821 is cooled to the cooled temperature, the cooled hydrogen gas 821 may be transferred to a storage system 823. The storage system 823 may include one or more separators to separate any contaminants from the cooled hydrogen gas 821. In some embodiments, the storage system 823 may be a storage tank to store compressed gas. In some embodiments, the storage system 823 may include a solid-state storage system, such as a material that may adsorb the cooled hydrogen gas 821 for storage. In some embodiments, the storage system 823 may include any storage system to store the cooled hydrogen gas 821.

In some embodiments, the storage system 823 may include a transfer system to transfer the compressed gas to another location. For example, the storage system 823 may include a set of pipes that may transport the cooled hydrogen gas 821 to another location. The transfer system may transfer the cooled hydrogen gas 821 to any location. For example, the cooled hydrogen gas 821 may be ultimately used at an ammonia production reactor, as discussed herein. In some examples, the cooled hydrogen gas 821 may ultimately be used at a hydrogen electricity generator. In some examples, the cooled hydrogen gas 821 may ultimately be used in a fuel cell. In some examples, the cooled hydrogen gas 821 may be used in any other manner.

In some situations, to reach a target pressure, a compression and cooling system 815 may include multiple stages of compressors 811 and cooling systems 819. For example, the compressor 811 may not be able to compress the hydrogen gas 809 to a target pressure in a single stage. This may be due to the heated gas temperature of the compressed hydrogen gas 817 being higher than an operating temperature of the compressor 811. To reach the target pressure, the compression and cooling system may include multiple stages of compressors 811 and/or cooling systems 819.

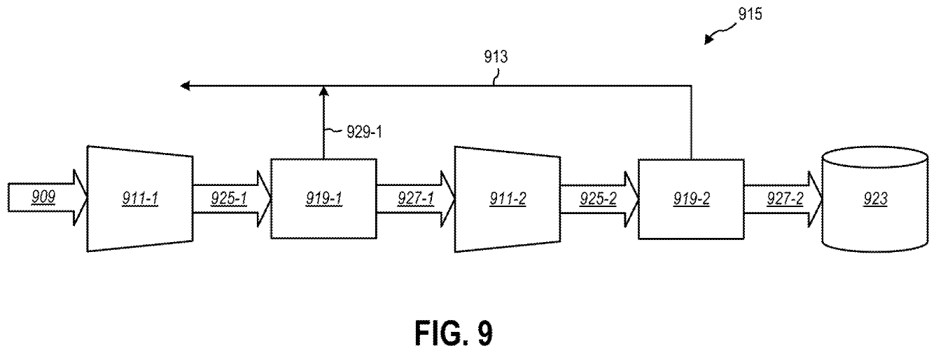

As a specific, non-limiting example, FIG. 9 is a representation of a multi-stage compression and cooling system 915 having multiple stages of compressors (collectively 911) and cooling systems (collectively 919), according to at least one embodiment of the present disclosure. Gas 909 may be fed into a first compressor 911-1. The gas 909 may include any type of gas, such as hydrogen gas, oxygen gas, atmospheric gas, ammonia gas, any other gas, and combinations thereof. In some embodiments, the gas 909 may be an output of an electrolyzer. For example, the gas 909 may include the outputted oxygen gas and hydrogen gas from an electrolysis system. In some embodiments, the gas 909 may include a single pure gas. In some embodiments, the gas 909 may include a mixture of multiple gasses. The first compressor 911-1 may compress the gas 909 to a first high-temperature gas 925-1. A first cooling system 919-1 may cool the first high-temperature gas 925-1 to a first cooled gas 927-1. The first cooled gas 927-1 may be fed into a second compressor 911-2 and the second compressor 911-2 may compress the first cooled gas 927-1 to a second high-temperature gas 925-2. A second cooling system 919-2 may cool the second high-temperature gas 925-2 to a second cooled gas 927-2. The second cooled gas 927-2 may be transferred to a storage system 923.

While the embodiment in FIG. 9 is illustrated as including two stages of compressors 911 and cooling systems 919, it should be understood that the present disclosure is applicable to any number of stages of compressors 911 and cooling system 919. For example, multi-stage compression and cooling systems 915 of the present disclosure may include 1, 2, 3, 4, 5, 6, 7, 8, 9, 10, 11, 12, 13, 14, 15, 16, 17, 18, 19, 20, or more stages. In some embodiments, the number of stages may be based on the heated gas temperature and/or the cooled gas temperature. For example, the number of stages may be increased if the heated gas temperature is relatively lower, because the compressor for each stage may compress each stage to a relatively lower pressure increase by stopping at a lower temperature. In some examples, the number of stages may be decreased if the heated gas temperature is relatively higher, because the compressor for each stage may compress each stage to a relatively higher pressure increase by stopping at a higher temperature. In some examples, the number of stages may be decreased if the cooled gas temperature is relatively lower, because the compressor for each stage may compress each stage to a relatively higher pressure increase by starting at a lower temperature. In some examples, the number of stages may be increased if the cooled gas temperature is relatively higher, because the compressor for each stage may compress each stage to a relatively lower pressure increase by starting at a higher temperature.

Conventionally, compression and cooling systems seek to reduce the number of compression stages in the system. This may reduce capital and/or operating costs by reducing the number of compressors and/or cooling systems. In some situations, conventional compression and cooling systems may cool a gas to below the boiling point of water, which may decrease the number of stages, as discussed above.

In accordance with at least one embodiment of the present disclosure, the cooling systems 919 may transfer at least a portion of absorbed heat (collectively 929) to a heat transfer system 913. For example, the first cooling system 919-1 may cool the first high-temperature gas 925-1, resulting in first absorbed heat 929-1. The first absorbed heat 929-1 may be transferred to the heat transfer system 913. For example, the heat transfer system 913 may be in thermal communication with the first cooling system 919-1. When the first cooling system 919-1 cools the first high-temperature gas 925-1, the heat transfer system 913 may receive the first absorbed heat 929-1 from the first cooling system 919-1. The second cooling system 919-2 may cool the second high-temperature gas 925-2, resulting in second absorbed heat 929-2. The second absorbed heat 929-2 may be transferred to the heat transfer system 913. For example, the heat transfer system 913 may be in thermal communication with the second cooling system 919-2. When the second cooling system 919-2 cools the second high-temperature gas 925-2, the heat transfer system 913 may receive the second absorbed heat 929-2 from the second cooling system 919-2.

The heat transfer system 913 may transfer the absorbed heat 929 to be recycled in a separate portion of a system. For example, as discussed herein, the heat transfer system 913 may transfer the absorbed heat 929 to be recycled by a steam generation system to generate steam for steam electrolysis. In some examples, the heat transfer system 913 may transfer the absorbed heat 929 to be used by any other system, including to pre-heat gas used in ammonia generation, to pre-heat steam used in steam electrolysis, in a desalination system, to generate steam to facilitate hydrogen combustion, for any other use, and combinations thereof.

As will be understood, each stage of the multi-stage compression and cooling system 915 (where a stage includes a compressor 911 and a cooling system 919) may have an associated heated gas temperature (e.g., the temperature of the high-temperature gas 925) and a cooled gas temperature (e.g., the temperature of the cooled gas 927). In some embodiments, each stage may have the same heated gas temperature. For example, each compressor 911 may compress the input gas until the gas reaches the heated gas temperature. In this manner, the heated gas temperature may be a temperature threshold to which the compressors 911 compresses the input gas. In some embodiments, different stages may have different heated gas temperatures. For example, different stages may have different compressors 911 having different specifications, resulting in different heated gas temperatures. In some examples, the input gasses to different compressor 911 stages may have different input pressures, with later stages having higher gas input pressure. Different compressors 911 may be used for different input pressures. This may result in different heated gas temperatures.

In some embodiments, each stage may have the same cooled gas temperature. For example, the cooling systems 919 may cool the cooled gas 927 to the same cooled gas temperature. As discussed herein, the cooled gas temperature of each stage may be higher than the boiling point of water. This may allow the absorbed heat 929 to be used to generate steam. In some examples, the cooled gas temperature for different stages may be different. For example, one or more of the stages may cool the compressed gas to a cooled gas temperature that is associated with an input temperature for a particular compressor 911. In this manner, the heated gas temperature and/or the cooled gas temperature may be tailored to the compressors 911 of the stages of the multi-stage compression and cooling system 915.

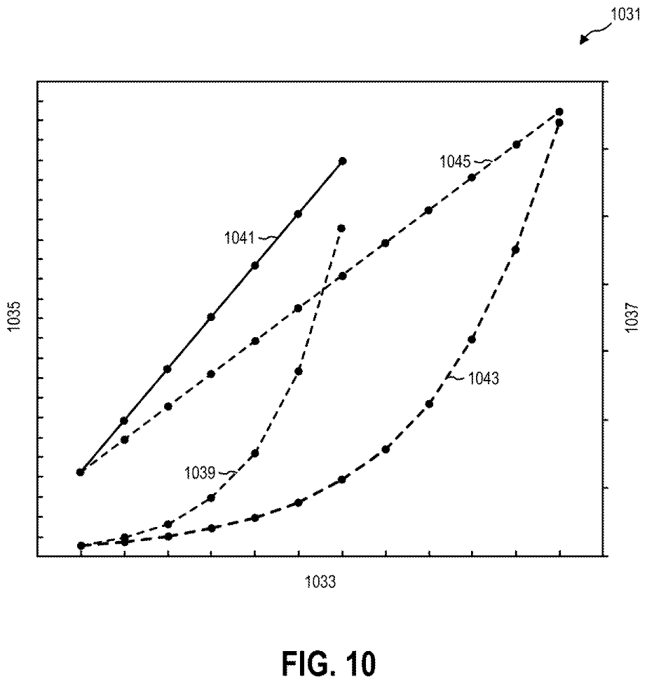

FIG. 10 is a representation of a temperature and compression chart 1031 for a multi-stage compression and cooling system, according to at least one embodiment of the present disclosure. The temperature and compression chart 1031 illustrated includes stages 1033 on the horizontal axis (x-axis), pressure 1035 on the left vertical axis (left y-axis), and heat recovery 1037 on the right vertical axis (right y-axis). The temperature and compression chart 1031 includes a low temperature compression line 1039 and associated low temperature heat absorption line 1041, each of which are associated with a low cooled gas temperature (e.g., below the boiling point of water). The temperature and compression chart 1031 further includes a high temperature compression line 1043 and associated high temperature heat absorption line 1045, each of which are associated with a high cooled gas temperature (e.g., above the boiling point of water).

The relationship between the compression lines and the heat absorption lines may indicate how much heat is capable of being absorbed to reach a particular pressure. As may be seen, for a particular point on the compression lines, the high temperature heat absorption line 1039 indicates that more heat is absorbable per stage.

As a specific, non-limiting example, a conventional compression and cooling system may cool the compressed gas to 75° C. during cooling. This may result in between 6 and 7 stages of cooling to reach 700 Bar pressure. The theoretical heat energy recovery possible is 2.75 kWhr/kg H₂ by intercooling from 170° C. to 75° C. after each stage of compression. However, when considering steam generation at a pressure of 1 bar, only thermal sources above 100° C. can provide sufficient heat input to generate the steam. Thermal recovery from 100-75° C. is only possible to pre-heat water to the boiler, or an upstream flash desalination process leading to a 35% loss of the total available heat and an actual heat recovery of 1.75 kWhr/kg H₂ which is only 47% of the 3.72 kWhr/kg H₂ steam duty.

In accordance with at least one embodiment of the present disclosure, cooling the compressed gas from 170° C. to 110° C. may result in a total recoverable energy of 2.95 kWhr/kg H₂, all of which is a high enough temperature to generate steam at 1 bar, amount to 79% of the steam duty of 3.72 kWhr/kg H₂. As may be seen, targeting a higher cooled gas temperature allows for the collection of more energy suitable for steam generation during cooling. In this manner, cooling the gas in accordance with embodiments of the present disclosure may result in recovered heat that is more usable (e.g., as a mechanism to generate steam) and recovers a larger portion of the heat from the steam duty, thereby increasing the overall efficiency of the system. In some embodiments, the collected heat may be sufficient to cover all steam-generation heat requirements.

In some embodiments, as discussed herein, pure oxygen generated during electrolysis may be collected. A separate compressor train for oxygen may be utilized and heat recovery could also be performed during compression of this additional gas stream in a similar manner. Furthermore, cooling compressed gas below 100° C. can still provide valuable heat to an upstream boiler water feed pre-heat or flash desalination process, the optimum intercooling temperature requires a specific techno-economic analysis.

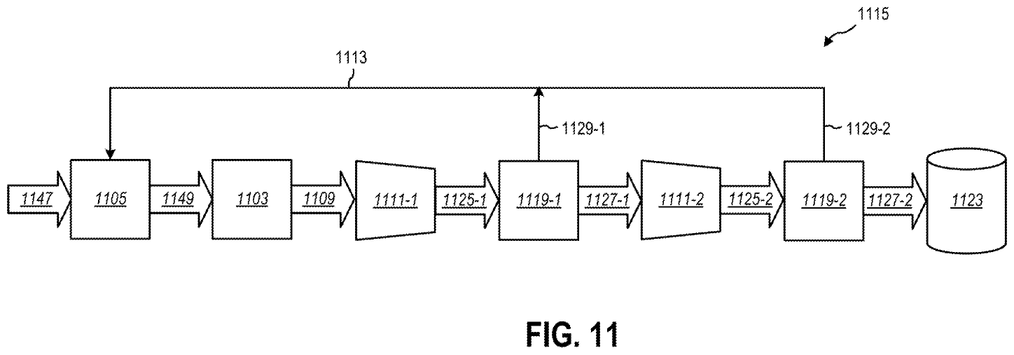

FIG. 11 is a representation of a multi-stage compression and cooling system 1115 having multiple stages of compressors (collectively 1111) and cooling systems (collectively 1119), according to at least one embodiment of the present disclosure. A steam generator 1105 may receive liquid water 1147 and convert the liquid water 1147 into steam 1149. The steam 1149 may be input into a steam electrolyzer 1103. The steam electrolyzer 1103 may generate hydrogen gas 1109. The hydrogen gas 1109 may be fed into a first compressor 1111-1. The first compressor 1111-1 may compress the 1109 to a first high-temperature gas 1125-1. A first cooling system 1119-1 may cool the first high-temperature gas 1125-1 to a first cooled gas 1127-1. The first cooled gas 1127-1 may be fed into a second compressor 1111-2 and the second compressor 1111-2 may compress the first cooled gas 1127-1 to a second high-temperature gas 1125-2. A second cooling system 1119-2 may cool the second high-temperature gas 1125-2 to a second cooled gas 1127-2. The second cooled gas 1127-2 may be transferred to a storage system 1123.

While the embodiment in FIG. 11 is illustrated as including two stages of compressors 1111 and cooling systems 1119, it should be understood that the present disclosure is applicable to any number of stages of compressors 1111 and cooling system 1119. For example, multi-stage compression and cooling systems 1115 of the present disclosure may include 1, 2, 3, 4, 5, 6, 7, 8, 9, 10, 11, 12, 13, 14, 15, 16, 17, 18, 19, 20, or more stages.

In accordance with at least one embodiment of the present disclosure, the cooling systems 1119 may transfer at least a portion of absorbed heat (collectively 1129) to a heat transfer system 1113. For example, the first cooling system 1119-1 may cool the first high-temperature gas 1125-1, resulting in first absorbed heat 1129-1. The first absorbed heat 1129-1 may be transferred to the heat transfer system 1113. For example, the heat transfer system 1113 may be in thermal communication with the first cooling system 1119-1. When the first cooling system 1119-1 cools the first high-temperature gas 1125-1, the heat transfer system 1113 may receive the first absorbed heat 1129-1 from the first cooling system 1119-1. The second cooling system 1119-2 may cool the second high-temperature gas 1125-2, resulting in second absorbed heat 1129-2. The second absorbed heat 1129-2 may be transferred to the heat transfer system 1113. For example, the heat transfer system 1113 may be in thermal communication with the second cooling system 1119-2. When the second cooling system 1119-2 cools the second high-temperature gas 1125-2, the heat transfer system 1113 may receive the second absorbed heat 1129-2 from the second cooling system 1119-2.

The heat transfer system 1113 may transfer the absorbed heat 1129 to the steam generator 1105. The absorbed heat 1129 may be utilized by the steam generator 1105 to heat the liquid water 1147 input into the steam generator 1105 to generate the steam 1149. In this manner, as discussed herein, absorbed heat 1129 may be used to reduce the energy input into the steam generator 1105. This may increase the overall efficiency of the multi-stage compression and cooling system 1115.

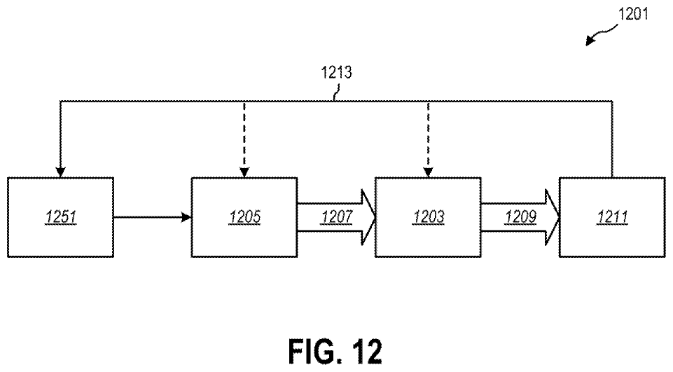

FIG. 12 is a representation of a steam electrolysis system 1201, according to at least one embodiment of the present disclosure. The steam electrolysis system 1201 includes a steam electrolyzer 1203. The steam electrolyzer 1203 may separate water into its component portions (e.g., hydrogen gas and oxygen gas). A steam generator 1205 may generate steam 1207 and pass the steam 1207 to the steam electrolyzer 1203. The steam electrolyzer 1203 may generate hydrogen gas 1209 from the steam 1207. The hydrogen gas 1209 may be passed to one or more compressors 1211. During compression of the hydrogen gas 1209 by the compressors 1211, the hydrogen gas 1209 may generate heat.

To maintain the hydrogen gas below an operating temperature of the compressors 1211, a cooling system may cool the compressors 1211 and/or the hydrogen gas 1209 by absorbing the compression heat. The absorbed heat may be transferred to the steam generator 1205 using a heat transfer system 1213. The absorbed heat may be used to generate at least a portion of the steam 1207. This may help to reduce the energy expended by the steam generator 1205 to generate the steam 1207. In some embodiments, this may help reduce and/or prevent the loss and/or waste of at least a portion of the heat generated by the compressors 1211. Put another way, the heat transfer system 1213 may recycle at least a portion of the heat generated at the compressors 1211 through compression of the hydrogen gas 1209.

In accordance with at least one embodiment of the present disclosure, the heat transfer system 1213 may transfer at least a portion of the absorbed heat from the compressors 1211 to a thermal store 1251. The thermal store 1251 may store at least a portion of the absorbed heat for later use. The steam generator 1205 may be in thermal communication with the thermal store 1251. When the steam generator 1205 generates steam, the steam generator 1205 may absorb heat from the thermal store 1251 to generate at least a portion of the steam 1207 used by the steam electrolyzer 1203.

In some embodiments, all of the steam 1207 generated by the steam generator 1205 may be generated using the heat from the thermal store 1251. In some embodiments, a portion of the steam 1207 generated by the steam generator 1205 may be generated using the heat from the thermal store 1251. In some embodiments, the steam generator 1205 may generate team using the thermal store 1251 when the thermal store 1251 reaches a threshold level of absorbed heat. In some embodiments, the thermal store 1251 may be a buffer for heat generated by the compressors 1211 if the generated heat exceeds the heat usage by the steam generator 1205.

In some embodiments, at least a portion of the heat from the heat transfer system 1213 and/or the thermal store 1251 may be used by the steam electrolyzer 1203. For example, the steam electrolyzer 1203 may use the heat from the heat transfer system 1213 and/or the thermal store 1251 may be used to pre-heat steam or other components of the steam electrolyzer 1203, thereby reducing the energy consumption of the steam electrolyzer 1203.

The thermal store 1251 may be any type of thermal storage and/or utilize any mechanism to store thermal energy. For example, the thermal store 1251 may include a phase-change material. The phase-change material may change from solid to liquid at a temperature that approximately matches the temperature of the absorbed heat in the heat transfer system 1213. The absorbed heat may melt the phase-change material, thereby storing the heat in the thermal energy used to melt the phase-change material. When the steam generator 1205 is ready to receive the absorbed heat, the input water may be passed through the melted phase-change material, and heat may pass from the melted phase-change material to the water, thereby causing the water to boil and convert to the steam 1207. The phase-change material may include any phase-change material, including waxes, metal alloys, and so forth.

In some embodiments, the thermal store 1251 may be charged using electricity. For example, the thermal store 1251 may be charged using electricity from the power grid. This may allow the thermal store 1251 to be charged at times when the compressors 1211 are not producing heat. In some embodiments, the thermal store 1251 may be charged during non-peak electricity time. This may help to reduce the operating cost of the steam generator 1205. In some embodiments, the thermal store 1251 may be charged (e.g., the thermal store 1251 is chargeable) using alternative energy and/or intermittent energy sources, such as solar energy, wind energy, any other alternative energy, and combinations thereof. In some embodiments, the thermal store 1251 may be charged (e.g., the thermal store 1251 is chargeable) using on-site energy generation. In some embodiments, the thermal store 1251 may be charged (e.g., the thermal store 1251 is chargeable) by absorbing heat from the sun. For example, the thermal store 1251 may be the focus of one or more solar collectors that may focus the thermal energy of the sun at the thermal store 1251. The solar collectors may include any solar collector, such as mirrors, magnifying lenses, geodesic domes, any other solar collector, and combinations thereof.

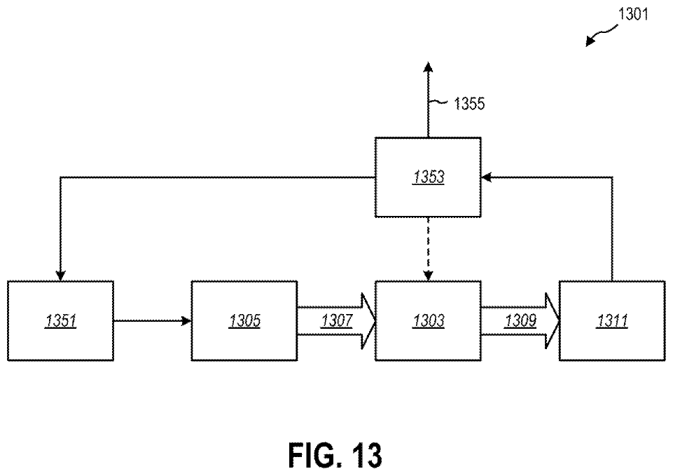

FIG. 13 is a representation of a steam electrolysis system 1301, according to at least one embodiment of the present disclosure. The steam electrolysis system 1301 includes a steam electrolyzer 1303. The steam electrolyzer 1303 may separate water into its component portions (e.g., hydrogen gas and oxygen gas). A steam generator 1305 may generate steam 1307 and pass the steam 1307 to the steam electrolyzer 1303. The steam electrolyzer 1303 may generate hydrogen gas 1309 from the steam 1307. The hydrogen gas 1309 may be passed to one or more compressors 1311. During compression of the hydrogen gas 1309 by the compressors 1311, the hydrogen gas 1309 may generate heat. To maintain the hydrogen gas below an operating temperature of the compressors 1311, a cooling system may cool the compressors 1311 and/or the hydrogen gas 1309 by absorbing the compression heat.

The compressed hydrogen gas may be transferred to a generator 1353. The generator 1353 may be a hydrogen combustion generator. The generator 1353 may combust the hydrogen gas, thereby generating electricity 1355 and thermal energy. The electricity 1355 may be used in any manner. For example, the electricity 1355 may be transmitted to the grid, where it may be used at any location on the grid. In some examples, the electricity 1355 may be used in a local process. For example, the electricity 1355 may be used to at least partially power the steam electrolyzer 1303 and/or the steam generator 1305.

In some embodiments, at least a portion of the generated heat may be transmitted to a thermal store 1351. As discussed herein, the thermal store 1351 may store the generated heat for later use. For example, the thermal store 1351 may be used by the steam generator 1305 to generate the steam 1307 at the steam generator 1305.

By combusting the hydrogen gas in the generator 1353, the steam electrolysis system 1301 may help to improve the energy efficiency of the steam electrolysis system 1301 and/or reduce the energy consumption of the steam electrolysis system 1301.

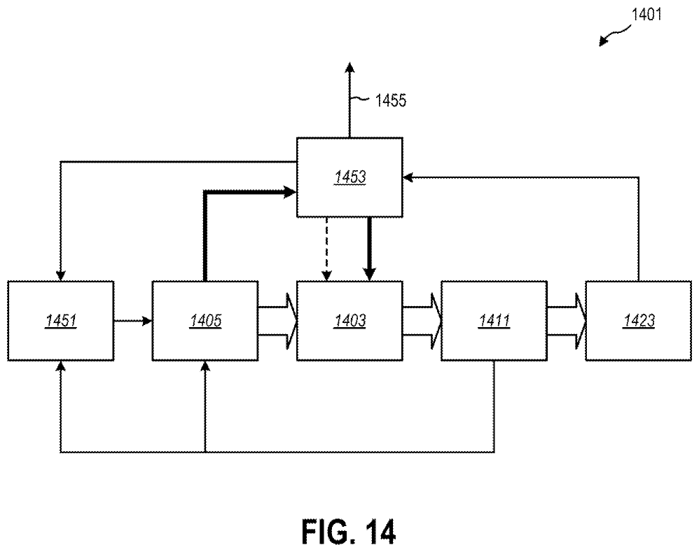

FIG. 14 is a representation of a steam electrolysis system 1401, according to at least one embodiment of the present disclosure. The steam electrolysis system 1401 includes a steam electrolyzer 1403. The steam electrolyzer 1403 may separate water into its component portions (e.g., hydrogen gas and oxygen gas). A steam generator 1405 may generate steam and pass the steam 1407 to the steam electrolyzer 1403. The steam electrolyzer 1403 may generate hydrogen gas from the steam. The hydrogen gas may be passed to one or more compressors 1411. During compression of the hydrogen gas by the compressors 1411, the hydrogen gas may generate heat. To maintain the hydrogen gas below an operating temperature of the compressors 1411, a cooling system may cool the compressors 1411 and/or the hydrogen gas by absorbing the compression heat.

The compressed and cooled gas may be used in a generator 1453 to generate electricity 1455. The compressed and cooled gas may first be collected and/or transmitted to the generator 1453 using a storage and transportation system 1423. Combustion of the hydrogen gas in the generator 1453 results in heat and water vapor.

As discussed herein, the heat generated during combustion of the hydrogen gas may be transferred and/or absorbed by a thermal store 1451. The thermal store 1451 may absorb the heat and transmit the heat to one or more of the steam generator 1405 or the steam electrolyzer 1403. For example, the thermal store 1451 may be in thermal communication with the steam generator 1405, and the steam electrolyzer 1403. During operation of the steam generator 1405, heat in the thermal store 1451 may be used to generate steam and/or pre-heat the steam prior to electrolysis in the steam electrolyzer 1403. In some embodiments, heat from the thermal store 1451 may be used to provide heat for electrolysis in the steam electrolyzer 1403.

As discussed herein, heat generated by compression of the hydrogen gas may be transferred to the thermal store 1451 and/or the steam generator 1405.

In some embodiments, heat from the generator 1453 may be absorbed by the thermal store 1451 at a temperature higher than the boiling point of water. In some embodiments, the heat from the generator 1453 may be absorbed by the thermal store 1451 at a temperature higher than heat generated and absorbed from the compressors 1411. This may be because the combustion of the hydrogen gas occurs at a higher temperature than the temperature of the compression of the hydrogen gas.

In some embodiments, the thermal store 1451 may include two sections. A first section of the thermal store 1451 may be a high-temperature section used to store heat generated during the combustion of hydrogen gas. A second section of the thermal store 1451 may be a low-temperature section used to store heat generated during the compression of the hydrogen gas. The absorbed heat from the different sections may be used for different purposes. For example, as discussed herein, heat from the second section may be used to generate steam at the steam generator 1405. Heat from the first section may be used to further heat that steam to pre-heat it prior to electrolysis. In some embodiments, heat from the first section may be used to pre-heat gasses for the production of ammonia, as discussed in further detail herein.

In some embodiments, the generator 1453 may utilize a portion of the steam generated by the steam generator 1405 to facilitate the combustion of the hydrogen gas. Adding a portion of steam to the hydrogen and oxygen gas feeds may help to reduce the explosivity of the hydrogen and/or control the combustion reaction.

In some embodiments, the water generated during combustion of the hydrogen gas may be captured as steam. The steam may be cooled, and the thermal energy stored in the thermal store 1451. In some embodiments, the steam may be condensed and/or stored for later use in electrolysis by the steam electrolyzer 1403. In some embodiments, the electricity generated by the generator 1453 may be used to power the steam electrolyzer 1403.

In some embodiments, the oxygen generated by the steam electrolyzer 1403 may be collected at an oxygen gas collection system. The collected oxygen may be compressed by the compressors 1411 and/or stored by the storage and transportation system 1423. The collected oxygen gas may be used at the generator 1453 during combustion of the hydrogen gas. Using oxygen gas may increase the efficiency of the combustion of the hydrogen gas in the generator 1453.

In some embodiments, the steam electrolysis system 1401 may be a closed system. For example, the water generated during hydrogen combustion may be collected at a water collection system. If the water vapor condenses to a liquid, the liquid water may be converted to steam by the steam generator 1405. The steam in the system (generated by the steam generator 1405 and/or stored from the combustion of the hydrogen gas) may be used by the steam electrolyzer 1403 to be separated into oxygen gas and hydrogen gas. The oxygen gas and hydrogen gas may be collected and stored (and optionally compressed by the compressors 1411). The oxygen gas and hydrogen gas may be combusted at the generator 1453 and the cycle repeated. In this manner, the steam electrolysis system 1401 may be a closed system with respect to water. This may help to reduce the water consumption of the steam electrolysis system 1401. This may help to improve the applicability of the steam electrolysis system 1401 in desert climates.

As discussed herein, recycling energy in the form of heat may help to increase the efficiency of the steam electrolysis system 1401. This may help to reduce the amount of external energy utilized to operate the steam electrolyzer 1403, the steam generator 1405, and/or the compressors 1411.

In some embodiments, the steam electrolysis system 1401 may be implemented as an energy storage system. For example, electricity may initially be input into the steam electrolyzer 1403 to generate hydrogen gas and oxygen gas. The hydrogen gas and oxygen gas may be stored until it is desirable to generate additional electricity. At this time, the generator 1453 may combust the hydrogen gas and the oxygen gas, generating electricity. In this manner, the energy input to electrolyze the water may be “stored,” and at least a portion of the energy may be recaptured during combustion of the hydrogen and oxygen. As discussed herein, capturing the generated heat and/or storing the generated heat may help to improve the efficiency of the steam electrolysis system 1401, thereby improving the amount of energy recaptured during combustion.

### INDUSTRIAL APPLICABILITY

The present disclosure relates generally to embodiments of an ammonia production system utilizing electricity and heat recapture and recycling from a hydrogen combustor to one or more stages of the ammonia production process. For example, a hydrogen combustor can combust a portion of available hydrogen in combination with air to produce heat, electricity, and a nitrogen feedstock. The heat and electricity from the nitrogen feedstock production can be recycled back to a renewable energy source or to a solid-oxide electrolysis cell (SOEC) to produce energy or reduce energy consumption.

In some embodiments, an ammonia production system reacts hydrogen feedstock (e.g., H₂) with a nitrogen feedstock (e.g., N₂) to produce ammonia (NH₃) in a reactor at an elevated temperature. For example, the reaction may be conducted at pressures above 10 MPa (100 bar; 1,450 psi) and between 400 and 500° C. (752 and 932° F.). In some examples, the reaction may be conducted at pressures as low as 100 psi. In some embodiments, the gases (nitrogen and hydrogen) are passed over beds of catalyst, with cooling between each pass for maintaining a reasonable equilibrium constant. In some examples, a partial conversion is achieved on each pass (e.g., about 15% conversion), but any unreacted gases are recycled through the reactor, and eventually an overall conversion of 97% of feedstock gases can be achieved. In some embodiments, the catalyst consists of iron bound to an iron oxide carrier containing promoters such as aluminium oxide, potassium oxide, calcium oxide, potassium hydroxide, molybdenum, magnesium oxide, other materials, or combinations thereof.

Producing the feedstock gases for the reaction conventionally requires an external power source and can consume large amounts of electricity. Some embodiments of ammonia production systems, according to the present disclosure, can capture and recycle heat and electricity from within the system to reduce energy consumption. Some embodiments of ammonia production systems, according to the present disclosure, can include variable renewable energy (VRE) sources or imported off-peak electricity to further reduce carbon by-products of the system. In some embodiments, electricity and/or heat from the system is recycled to the VRE sources to further reduce energy consumption of the system.

In a conventional ammonia production system, nitrogen feedstock gas is produced through either membrane separation of pressure swing adsorption, both of which consume electricity to produce the nitrogen feedstock. In some embodiments, according to the present disclosure, a hydrogen combustor is used to combust hydrogen gas in the presence of air to produce a nitrogen feedstock in an exothermic reaction. In some examples, heat from the exothermic reaction is recycled to vaporize water (in preparation for electrolysis of the water). In some examples, the exothermic reaction can drive a turbine or internal combustion engine to produce electricity, which is used to power the electrolysis of the water. The heat and electricity by-products of the hydrogen combustion can, thereby, offset at least a portion of the energy consumed during production of the hydrogen feedstock.

In other examples, heat from the hydrogen combustor can be recycled to the ammonia reactor (i.e., the Haber-Bosch reactor) to produce the elevated temperatures for the Haber-Bosch reaction. In yet other examples, heat from the hydrogen combustor can be recycled to a VRE source, such as a low-temperature (e.g., 90° C. or less) solar thermal generator to assist in producing electricity for the ammonia production system. In yet further examples, waste heat from the Haber-Bosch reaction can be recycled to vaporize water for electrolysis and/or for electricity production in a VRE source.

In some embodiments, the ammonia production system includes a hydrogen combustor. A solid-oxide electrolysis cell (SOEC) provides hydrogen (H₂) feedstock and water (H₂O) to the hydrogen combustor. The hydrogen combustor combusts at least a portion of the hydrogen feedstock with air in an exothermic reaction to produce heat and electricity. The combustion results in products including nitrogen feedstock that is exhausted with water to a condenser. In some embodiments, the condenser condenses and removes at least a portion of the water from the input gases (e.g., the nitrogen feedstock and water). The wastewater condensed by the condenser may be recycled elsewhere in the ammonia production system.

While embodiments of the present disclosure discuss the electrolysis of water using an SOEC, it should be understood that electrolysis may occur using any type of electrolysis system, including high-temperature electrolysis systems, low-temperature electrolysis systems, high-pressure electrolysis systems, low-pressure electrolysis systems, and combinations thereof. Examples of electrolysis systems include a Hofmann voltameter, alkaline water electrolysis, a proton exchange membrane, supercritical water, nickel/iron electrolysis, nanogap electrochemical cells, a capillary fed electrolyzer cell, any other electrolysis system, and combinations thereof. In some embodiments, as discussed herein, electrolysis may be performed using water purified with a desalination system.

In some embodiments, the hydrogen combustor includes a turbine generator that converts an expansion of the combustion reaction into electricity through the rotation of a shaft coupled to the turbine(s). In some embodiments, the hydrogen combustor includes an internal combustion generator that converts an expansion of the combustion reaction within one or more cylinders into electricity through the rotation of a shaft coupled to a piston moveable within the cylinder(s). The hydrogen combustor may convert the expansion of the gases during the combustion reaction into electricity in any relevant manner.

The heat produced by the hydrogen combustor, in some embodiments, is provided to one or more of a thermal power generation cycle, a steam generator, or other components of the ammonia production system. The heat from the hydrogen combustor is provided to the thermal power generation cycle, steam generator, or other component to reduce the amount of energy consumed to heat the respective components. For example, a steam generator may use resistive heating that consumes electricity to heat one or more heating elements through a resistance in the heating element, which dissipates at least a portion of the electrical power as heat. Resistive heating can consume a large amount of electricity. Using waste heat from other components of the ammonia production system, such as the hydrogen combustor, can reduce and/or eliminate the electricity consumption of the steam generator.

In other examples, a thermal power generation cycle may use heat to generate electricity, allowing waste heat from the hydrogen combustor and/or other components of the ammonia production system to be converted into electricity. For example, the electricity produced by the thermal power generation cycle may be provided to the SOEC.

In some embodiments, electricity is further provided to a compression train that compresses one or more feedstock gases (e.g., hydrogen feedstock and nitrogen feedstock). In some embodiments, the feedstock gases are in a single mass flow from the SOEC and the condenser, and the feedstock gases may be compressed in the compression train together in a shared volume. In some embodiments, the feedstock gases may be compressed in separate compression trains. For example, the compressibility of the feedstock gases may be different, and different quantity of compression steps or different compression ratios at each compression steps may be different for the different feedstock gases. As will be described herein, in some embodiments, a compression train, according to the present disclosure, may maintain a temperature of the feedstock gases above a selected temperature to allow recycling of heat from the compressor(s) of the compression train to the steam generator or other components of the ammonia production system.

In some embodiments, the SOEC produces hydrogen feedstock from water that is supplied by a steam generator. The steam generator heats the water above the boiling temperature to produce steam that is provided to the SOEC. In some embodiments, the steam generator includes resistive heating elements to heat the water. In some embodiments, the steam generator heats the water with a heat pump. In some embodiments, the steam generator consumes less energy than a conventional ammonia production system by recycling at least a portion of the heat produced elsewhere in the ammonia production system to heat and/or vaporize the water.

In some embodiments, the ammonia production system further includes a desalination device. For example, the desalination device may receive input water from a saline source, such as ocean water, and desalinate the water for use in the ammonia production system. In some embodiments, the desalination device provides water to the steam generator to produce steam that is more easily electrolyzed by the SOEC. In some embodiments, desalinated water is used to fill an energy storage system, provided a coolant in heat exchange cycles, provide water to the thermal power generation cycle, provide water to the steam generator, or combinations thereof. Desalination to the target requirement of SOEC's has a significant energy requirement that can be delivered by a VRE source, from the thermal power generation cycle, through a Reverse Osmosis (RO) process, through supplemental heat recycled from other components of the ammonia production system, or combinations thereof. Thermal desalination is, therefore, an opportunity to recycle heat from thermal storage or other components of the ammonia production system to provide at least a portion of the required energy load for desalination.

For example, there are at least two methods that can be integrated into a combined progress, which each provide additional energy efficiency through the use of either heat or electricity. The specific VRE source may affect the amount of heat recycled to the desalination. In some examples, as the balance of generation from a concentrated solar thermal generator shifts toward more electricity, or more thermal capacity per square-meter of receiver area, a surplus of either may emerge. A future increase in photovoltaic efficiency may favor more electricity, driving the use of a more economical RO processes. If the thermal tolerance of photovoltaic cells improves at a proportionally higher rate in the future, an increase in temperature and heat load may favor thermal desalination.

After producing the hydrogen feedstock and the nitrogen feedstock, an ammonia production system may include an ammonia reactor (such as a Haber-Bosch reactor) or other reactor to produce ammonia. The ammonia may then be delivered to an ammonia storage device for distribution, packaging, further treatment, or combination with other produces.

In some embodiments, the ammonia is the final product of the ammonia production system. For example, the ammonia can be exported or combusted to generate energy on demand for the process or network electricity demand. In some embodiments, the ammonia production system is part of a production system for another product, and the ammonia is provided as a part of another product.

In some embodiments, according to the present disclosure, only the Haber-Bosch synthesis loop is required, with nitrogen feedstock and hydrogen feedstock fed by the SOEC and hydrogen combustor and the heating and compression train powered by the VRE source.

The ammonia reactor, in some embodiments, produces heat that is recycled to other components of the ammonia production system. In some embodiments, an exothermic reaction across an iron-based catalyst bed creates a high temperature discharge stream from the reactor. This high temperature heat load at ˜500° C. discharged from the reactor is recycled into the working fluid in the thermal cycle, as superheat, with the residual heatload used for preheating the compressed feedstock (e.g., nitrogen feedstock and hydrogen feedstock) stream from the compression train to the ammonia reactor. Further cooling requirements for the nitrogen feedstock, hydrogen feedstock, and ammonia stream(s) are provided by a low temperature chiller, with the rejected heat returned to the hot storage. The thermal storage system further improves the exchange efficiency.

In some embodiments, ammonia is separated through a multistage separator in or after the ammonia reactor, which allows nitrogen feedstock and hydrogen feedstock 106 to be recycled back into the compression train, for reprocessing. The typical single pass Haber-Bosch reactor yield is between 12 and 18%. Further development of catalysts and electrolytic cells may improve the yield value further. Further advances in both conversion options provide further efficiency to drive down the levelized cost of ammonia according to the present disclosure. The utilization of the exothermic heat recycled back into the thermal power generation cycle and other components of the ammonia production system to boost efficiency of the ammonia production system allows less energy consumption and lower cost of operations compared to a conventional Haber-Bosch synthesis loop production system.

In some embodiments, heat is recycled from a heat source component to a heat sink component in the ammonia production system directly through a thermal conduit. A heat source component is any component of the ammonia production system that produces heat and/or has heat produced therein during operation, such as by an exothermic reaction. For example, a heat source component includes the hydrogen combustor, the compression train, the ammonia reactor, and the VRE source. A heat sink component is any component of the ammonia production system that receives heat or consumes heat during operation. For example, a heat sink component includes the steam generator, the thermal energy generation cycle, and the desalination device. In some examples, a component may selectively be a heat source component and/or a heat sink component, such as the ammonia reactor which can be heated prior to a Haber-Bosch cycle but also produces heat through the exothermic reaction. In some embodiments, the ammonia reactor can receive heat to preheat the ammonia reactor and then export heat after the exothermic reaction.

In some embodiments, the heat is transferred from a heat source component to a heat sink component through a thermal conduit that conducts heat and/or transfers heat through a mass flow. For example, some thermal conduits may be a solid-state thermal conduit that conduct heat through thermally conductive solid mass, such as a rod or sheet between the heat source component and the heat sink component. In some examples, the thermal conduit is a solid copper conduit. In other examples, some thermal conduits may be a fluid-based conduit that flows a working fluid through and/or in at least a portion of the conduit to move heat from the heat source component and the heat sink component. For example, the working fluid may be water. In other examples, particularly those transferring heat from a heat source component with a temperature above the boiling temperature of water, the working fluid may be a different working fluid with a higher boiling temperature to allow the working fluid to remain liquid while transferring heat. In yet other examples, the working fluid may be a multi-phase working fluid that changes physical state during the heat transfer process. As the latent heat of boiling allows the working fluid to receive additional heat without an associated increase in temperature, a multi-phase working fluid can further increase the heat transfer efficiency of a thermal conduit.

In some embodiments, one or more of the thermal conduits that move heat from a heat source component to a heat sink component is a dedicated conduit. For example, the thermal conduit is configured to move heat only from a heat source component to a heat sink component. In some embodiments, one or more of the thermal conduits that move heat from a heat source component to a heat sink component is a shared conduit. For example, the thermal conduit is configured to transfer heat from a plurality of heat source components to a single heat sink component, from a single heat source component to a plurality of heat sink components, or from a plurality of heat source components to a plurality of heat sink components.

In some embodiments, heat is recycled from a heat source component to a heat sink component in the ammonia production system indirectly through a thermal storage device. For example, a thermal storage device may be positioned in or along any of the thermal conduits that receives heat from a heat source component and stores the heat for subsequent transfer to a heat sink component. In some embodiments, one or more thermal storage devices are dedicated thermal storage devices. For example, the dedicated thermal storage device is positioned in or along a dedicated thermal conduit. In some embodiments, one or more thermal storage devices are shared thermal storage devices. For example, the shared thermal storage device is positioned in or along a shared thermal conduit.

One or more electrical conduits, in some embodiments, are configured to provide electrical communication between an electrical source component and an electrical sink component. In some embodiments, one or more of the electrical conduits that move electricity from an electrical source component to an electrical sink component is a dedicated conduit. For example, the electrical conduit is configured to provide electricity only from an electrical source component to an electrical sink component. In some embodiments, one or more of the electrical conduits that conduct electricity from the electrical source component to the electrical sink component is a shared electrical conduit. For example, the electrical conduit is configured to transfer electricity from a plurality of electrical source components to a single electrical sink component, from a single electrical source component to a plurality of electrical sink components, or from a plurality of electrical source components to a plurality of electrical sink components.

In some embodiments, electricity is recycled from an electrical source component to an electrical sink component in the ammonia production system indirectly through an electrical storage device, such as a battery, capacitor, or other electrical storage device. For example, an electrical storage device may be positioned in or along any of the electrical conduits that receives electricity from an electrical source component and stores the electricity for subsequent transfer to an electrical sink component. In some embodiments, one or more electrical storage devices are dedicated electrical storage devices. For example, the dedicated electrical storage device is positioned in or along a dedicated electrical conduit. In some embodiments, one or more electrical storage devices are shared electrical storage devices. For example, the shared electrical storage device is positioned in or along a shared electrical conduit.

In some embodiments, a method of ammonia production includes producing steam with a steam generating device and delivering the steam to an electrolyzer cell. In some embodiments, the electrolyzer cell is a SOEC such as described herein. The method further includes electrolyzing the steam to form hydrogen gas. In some embodiments, the steam is not fully converted into hydrogen gas and oxygen gas, and at least a portion of the water remains in the electrolyzer cell. The unreacted water may be removed when the other gases are removed from the electrolyzer cell, or the unreacted water may remain in or be recycled back into the electrolyzer cell for further processing.

The method further includes providing the hydrogen gas from the electrolyzer cell to a hydrogen combustor and combusting the hydrogen gas with air to produce nitrogen, water vapor, electricity, and heat. In some embodiments, providing the hydrogen gas to the hydrogen combustor includes dividing the hydrogen gas produced in the electrolyzer cell into a first stream directed to the hydrogen combustor and a second stream directed to a compression train. For example, the first stream of hydrogen gas to the hydrogen combustor may include approximately 50% of the hydrogen gas produced by the electrolyzer cell, while the second stream of hydrogen gas to the compression train includes the remaining approximately 50% of the hydrogen gas. In other examples, the first stream of hydrogen gas to the hydrogen combustor may include less than 50%, such as approximately 15% of the hydrogen gas produced by the electrolyzer cell, while the second stream of hydrogen gas to the compression train includes the remaining hydrogen gas, such as approximately 85% of the hydrogen gas. In yet other examples, the first stream of hydrogen gas to the hydrogen combustor may include greater than 50%, such as approximately 70% of the hydrogen gas produced by the electrolyzer cell, while the second stream of hydrogen gas to the compression train includes the remaining hydrogen gas, such as approximately 30% of the hydrogen gas.

In some embodiments, combusting the hydrogen gas with air occurs in a hydrogen combustor including or coupled to an electrical generator that converts an expansion caused by the combustion into electricity. In some examples, the electrical generator converts the expansion into electricity through the expansion rotating a turbine. In some examples, the electrical generator converts the expansion into electricity through the expansion moving pistons that rotate a shaft. The rotation of the turbine and/or shaft can be converted to electricity to produce the electricity.

After the nitrogen, water vapor, electricity, and heat are produced, the method includes recycling at least a portion of the heat to the steam generation device and recycling at least a portion of the electricity to the electrolyzer cell. In some embodiments, recycling the heat to the steam generation device includes transferring the heat through a combustion thermal conduit from the hydrogen combustor to the steam generation device. For example, the combustion thermal conduit may be a dedicated conduit. In other examples, the combustion thermal conduit may be a shared conduit that receives heat from the hydrogen combustor. In yet other examples, the combustion thermal conduit may be a shared thermal conduit that provides heat to the steam generator from at least the hydrogen combustor. In some embodiments, the combustion thermal conduit includes a thermal storage device in or along the combustion thermal conduit that allows heat to be transferred from the hydrogen combustor to the thermal storage device. The thermal storage device may store the heat from the hydrogen combustor for at least some period of time before releasing the heat to the steam generator device.

In some embodiments, recycling at least a portion of the electricity to the electrolyzer cell includes transferring the heat through a combustion electrical conduit from the hydrogen combustor (and/or the electrical generator associated therewith) to the electrolyzer cell. For example, the combustion electrical conduit may be a dedicated electrical conduit. In other examples, the combustion electrical conduit may be a shared electrical conduit that receives electricity from the hydrogen combustor and/or electrical generator. In yet other examples, the combustion electrical conduit may be a shared electrical conduit that provides electricity to the electrolyzer cell from at least the hydrogen combustor and/or electrical generator. In some embodiments, the combustion electrical conduit includes an electrical storage device in or along the combustion electrical conduit that allows electricity to be transferred from the hydrogen combustor and/or electrical generator to the electrical storage device. The electrical storage device may store the electricity from the hydrogen combustor and/or electrical generator for at least some period of time before releasing the electricity to the electrolyzer cell.

In some embodiments, the thermal storage device receives heat from a plurality of heat source components. In some embodiments, a shared thermal storage device receives heat from a reactor thermal conduit and a shared conduit that provides heat from the hydrogen combustor and the compression train. The thermal storage device can store the heat and selective transfer the heat to the steam generation device to heat the steam generation device and reduce and/or eliminate energy consumption by the steam generation device. The steam generation device can then provide the steam to the SOEC, which provides the hydrogen feedstock to the hydrogen combustor. The resulting nitrogen feedstock is provided to the condenser and/or the compression train which compress the feedstock gases before the ammonia reactor that produces the ammonia.

In some embodiments, a plurality of thermal storage devices receives and distribute heat through the ammonia production system, allowing heat flow to be managed in response to demand. In some embodiments, a first thermal storage device is configured to receive heat from the reactor thermal conduit, a second thermal storage device is configured to receive heat from the compressor thermal conduit, and a third thermal storage device is configured to receive heat from the combustion thermal conduit. Each dedicated thermal storage device can selectively provide heat to the steam generation device independently. In some embodiments, the thermal conduits transferring heat from the thermal storage devices and to the thermal storage devices are each dedicated thermal conduits.

In some embodiments, thermal storage device of the ammonia production system includes both high temperature thermal storage device and low temperature thermal storage device. For example, the low temperature thermal storage device may be generated through a chiller, utilizing the energy generation from either the solar thermal generator, photovoltaic panels, wind, or other VRE Source, or imported off-peak electricity. Storage as chilled water, ice slurry, solid storage, or a phase change materials allows the recovery of the stored energy (i.e., heat sink) on demand.

In removing heat from the chilled fluid, the reject heat can be recovered through a heat pump or other heat exchange mechanism and also delivered to the high temperature thermal storage device. Stored heat can be directly exported to heat sink components such as desalination, steam generation, SOEC heating, and reactor pre-heating. Stored chilled solid/fluid/gas can be exported and applied directly in thermal management components within the ammonia production system, such as cooling, condensing, and compression applications.

The thermal energy generation cycle, in some embodiments, produces electricity to power one or more electrical loads in the ammonia production system by converting imported heat from the high temperature thermal storage device, from other heat source components in the ammonia production system, or from VRE sources such as solar thermal generators. The thermal energy generation cycle, in some embodiments, produces electricity based on a temperature difference between a hot portion heated, at least partially, by the imported heat (such as from the high temperature thermal storage device) and a cold portion chilled by, at least partially, the low temperature thermal storage. The thermal storage device(s) may, thereby, allow selective distribution of high or low temperatures to adjust electricity production.

In some embodiments, at least a part of an ammonia production system has a condenser configured to condense vapor phase water into liquid phase water and a separator to recycle liquid phase water to one or more components of the ammonia production system. In some embodiments, air, hydrogen feedstock, and vapor phase water are provided to the hydrogen combustor. For example, the hydrogen feedstock and the vapor phase water may be provided by the SOEC, such as described herein. The hydrogen combusts the hydrogen feedstock with the air to produce a nitrogen feedstock. The vapor phase water remains in the stream and continues with the nitrogen feedstock to the condenser.

In some embodiments, the condenser cools the stream of nitrogen feedstock and vapor phase water below the boiling temperature of the water (e.g., 100° C. or other boiling temperature relative to a pressure in the condenser), and the condenser passes the nitrogen feedstock and the liquid phase water to a separator. In some embodiments, the separator is integrated with the condenser in a single component. The separator separates the liquid phase water from the nitrogen feedstock and passes the nitrogen feedstock to the compression train while directing the liquid phase water to be recycled to other components and/or storage devices in the ammonia production system, such as the desalination device, the electrolyzer cell, the thermal energy generation cycle, and thermal management devices, via a water conduit such as a pipe.

In some embodiments, the combustion products (e.g., water and contaminants) remaining after combustion are returned to the steam generator, recycling at least a portion of the combustion heat. In some embodiments, the condenser is integrated with a steam generation device heat exchanger. Additional cooling may be provided by a low-temperature thermal storage device. The separator may be further integrated with the condenser and the steam generator for the efficient separation of gaseous nitrogen feedstock from the water in the combustion stream.

A compression train includes, in some embodiments, one or more separators to separate liquid phase water from the feedstock gases (e.g., hydrogen feedstock and nitrogen feedstock). In some embodiments, the compression train receives hydrogen feedstock from the electrolyzer cell and nitrogen feedstock. The Haber-Bosch ammonia synthesis cycle conventionally uses a catalyzed reaction of hydrogen feedstock and nitrogen feedstock over a catalyst at high pressures (e.g., 2500-3500 pounds per square inch) and high temperatures (e.g., 300-500° C.). To produce the high-pressure hydrogen feedstock and nitrogen feedstock stream at the inlet of the catalyst contactor, a compression train is, in some embodiments, used to compress the gases with an associated adiabatic compression heat produced as a byproduct. The heatload generated increasing the pressure of this gas stream (combined or separate), is comparable to steam energy requirement for the electrolyzer cell process, and at least a portion of the compression heat can be transferred to the steam generator to recycle the heat.

Conventionally, a compression train would be optimized for the lowest quantity of cycles to reach the pressure required. In some embodiments, according to the present disclosure, a compression train has five or more cycles to keep the minimum temperature consistent in each cycle and produce a heatload from each cycle that can be used for steam generation. In some embodiments, the heatload remains above 105° C. at one or more compressors and/or coolers in the compression train. In some embodiments, the heatload remains above 105° C. at all compressors and/or coolers in the compression train.

In some embodiments, the compression train includes a series of compressors and coolers to serially compress the feedstock stream (which produces an associated adiabatic compression heat) and cool the feedstock stream as it heats during compression. In some embodiments, the input stream (e.g., from the hydrogen combustor) includes vapor phase water. The vapor phase water is compressed and cooled through the compression train until the compression exceeds the vapor pressure of water at the temperature of the water. For example, in embodiments where the temperature of the stream remains above 105° C. throughout the compression train, the water will remain above the boiling temperature of water at atmosphere, but the compression train may, at some point, compress the vapor phase water pass the vapor pressure of the water at (or above), and the vapor phase water will condense into a liquid phase water. After compressing the water past the vapor pressure, the liquid phase water is, in some embodiments, removed from the feedstock stream through one or more separators. With each compression at a compressor, additional water may condense out and be removed with a separator.

In some embodiments, the minimum temperature of the stream in the compression train (or at one or more compressors and/or coolers in the compression train) is greater than 105° C. For example, the minimum temperature may be 110° C., 115° C., 120° C., 130° C. or another temperature that is greater than a boiling temperature of the water in the electrolyzer cell. In at least one example, the electrolyzer cell may be configured to operate at an elevated pressure, and the boiling temperature of water at the elevated pressure may be 130° C. A minimum temperature of the stream in the compression train greater than the boiling temperature of water at the elevated pressure may ensure the compression heat recycled to the electrolyzer cell heats the electrolyzer cell above the boiling temperature of the water being electrolyzed.

The compression train described herein, in some embodiments, is not the most efficient for compression, because the compression train maintains a minimum temperature of some or all of the compression cycles of approximately 105° C. In some embodiments, maintaining a minimum temperature value allows the reject heatload to be recovered and used directly for steam generation, without additional electrical heating equipment and cooling tower to discharge waste heat. Any additional heatload, not required at the electrolyzer cell or steam generator can be directed to the energy storage in the thermal system, and stored for later use, either as heat in a thermal storage device or electricity in an electrical storage device.

In some embodiments, a steam electrolysis system includes a steam electrolyzer. The steam electrolyzer may separate water into its component portions (e.g., hydrogen gas and oxygen gas). The steam electrolyzer may be any type of electrolyzer. For example, the steam electrolyzer may be a high-temperature electrolyzer, or an electrolyzer that operates at a relatively high temperature. In some embodiments, the steam electrolyzer may be a steam (e.g., water vapor) electrolyzer, that splits steam into hydrogen gas and oxygen gas. In some embodiments, the steam electrolyzer may include a solid-oxide electrolysis cell (SOEC). In some embodiments, the steam electrolyzer may be any electrolyzer that performs electrolysis using steam or water vapor. The steam electrolyzer may perform electrolysis with steam heated to an electrolysis temperature. The electrolysis temperature may include any electrolysis temperature, including 600° C., 700° C., 800° C., 900° C., 1,000° C., or any value therebetween.

A steam generator may generate steam and pass the steam to the steam electrolyzer. The steam generator may generate the steam from any water source. For example, as discussed herein, the steam generator may receive water to generate the steam from one or more utilities, rivers, lakes, wells, and/or desalination plants. As will be discussed in further detail herein, the steam generator may receive water to generate the steam from one or more combustion processes by combusting the hydrogen and/or the oxygen generated by the steam electrolyzer.

The steam electrolyzer may generate hydrogen gas. The hydrogen gas may be passed to one or more compressors. As may be understood, during compression of the hydrogen gas by the compressors, the hydrogen gas may generate heat. For example, heat may be generated based on the compression of the hydrogen gas, as may be understood based on the ideal gas law. The hydrogen gas may be compressed to a storage and/or transportation pressure.

To maintain the hydrogen gas below an operating temperature of the one or more compressors, a cooling system may cool the compressors and/or the hydrogen gas by absorbing the compression heat. The absorbed heat may be transferred to the steam generator using a heat transfer system. The absorbed heat may be used to generate at least a portion of the steam. This may help to reduce the energy expended by the steam generator to generate the steam. In some embodiments, this may help reduce and/or prevent the loss and/or waste of at least a portion of the heat generated by the compressors. Put another way, the heat transfer system may recycle at least a portion of the heat generated at the compressors through compression of the hydrogen gas.

While the present disclosure identifies that the compressors compress hydrogen gas, it should be understood that the steam electrolysis system may utilize heat generated from the compression of any gas. For example, the steam electrolysis system may be part of an ammonia production system. In the ammonia production system, the compressors may compress the nitrogen gas and/or the hydrogen gas used to produce the ammonia. In some embodiments, the compressors may compress a mixture of nitrogen and hydrogen gas. In some embodiments, a nitrogen compressor may compress nitrogen gas and a hydrogen compressor may compress hydrogen gas, with the nitrogen gas and the hydrogen gas compressed separately.

In some embodiments, the cooling system may cool the compressed gasses to a cooled temperature. The cooled temperature may be the lowest temperature to which the cooling system cools the compressed gases and/or the compressors. The heat transfer system may transfer the absorbed heat and re-use the heat to generate steam at the steam generator. The heat absorbed by the heat transfer system may be used to heat input water at the steam generator to approximately the cooled temperature (minus losses in the heat transfer system). For example, the heat transfer system may include a heat transfer medium that may be heated to the cooled temperature. The heat transfer medium of the heat transfer system may be applied to the input water at the steam generator, and the input water may absorb heat from the heat transfer medium. In some embodiments, the input water may be heated to approximately the temperature of the heat transfer medium (minus losses). In this manner, as discussed herein, the heat transferred from the compressors through the heat transfer system may be used to pre-heat the input water to approximately the cooled temperature of the compressors.

In accordance with at least one embodiment of the present disclosure, the heat transfer medium of the heat transfer system may be any heat transfer medium. For example, the heat transfer medium may include a liquid. The liquid may have a boiling point that is greater than the cooling temperature. The liquid may be transferred through pipes in the heat transfer system to the steam generator. In some examples, the heat transfer medium may include a gas that is transferred through pipes in the heat transfer system to the steam generator. In some examples, the heat transfer medium may include a solid material. The solid material may absorb the heat and transfer it to the steam generator. For example, liquid input water may be flowed through a sleave or pipe formed from a solid heat transfer medium. This may cause the input water to evaporate, generating steam. In some embodiments, the heat transfer medium may include a phase-change material, such as a liquid-to-gas phase-change material or a solid-to-liquid phase-change material.

In some embodiments, the system may include a desalination device instead of a steam generator or in addition to steam generator. For example, the desalination device may receive input water from a source that needs polishing, such as ocean water or underground water, and desalinate the water for use in an electrolysis system. In some embodiments, if the electrolyzer is a low temperature electrolyzer, the electrolyzer produces a hydrogen feedstock from liquid water and the desalination device provides water to the electrolyzer. In some embodiments, the desalination device provides water to the steam generator to produce steam that is more easily electrolyzed. In some embodiments, desalinated water is used to fill an energy storage system, provide a coolant in heat exchange cycles, provide water to a thermal power generation cycle, provide water to the steam generator, or combinations thereof. In accordance with at least one embodiment of the present disclosure, the absorbed heat may be used to desalinate water and/or heat the desalinated water to the target requirement of SOEC. Thermal desalination is, therefore, an opportunity to recycle heat to provide at least a portion of the required energy load for desalination.

In some embodiments, the cooling system may cool the gasses and/or the compressors to a cooled temperature that is greater than the boiling point of water. This may cause the heat transfer medium to be heated to greater than the boiling point of water. The heat transfer system may cause the input water to boil. In this manner, at least a portion of the energy used to compress the gasses at the compressors may be recycled (in the form of heat) and used to reduce the energy consumption at the steam generator by reducing the energy used to increase the temperature of the input water to the steam generator. This may help to improve the overall efficiency of the steam electrolysis system.

In some embodiments, a compression and cooling system includes a compressor. The compressor may receive hydrogen gas and compress it. While embodiments of the present disclosure are discussed with respect to hydrogen gas, it should be understood that the techniques described herein may be applied to any gas, such as hydrogen gas, oxygen gas, ammonia, atmospheric gas, any other gas, and combinations thereof. The compressed hydrogen gas may have a heated gas temperature. The heated gas temperature may be the highest temperature at which the compressor may operate. The compressed hydrogen gas may be cooled in a cooling system. The cooling system may absorb at least a portion of the heat from the compressed hydrogen gas. A heat transfer system may transfer at least a portion of the absorbed heat away from the cooling system. For example, the heat transfer system may transfer the absorbed heat to a steam generator in a steam electrolysis system.

In some embodiments, the heated gas temperature may be in a range having an upper value, a lower value, or upper and lower values including any of 135° C., 140° C., 150° C., 160° C., 170° C., 180° C., 190° C., 200° C., 210° C., 220° C., 230° C., 240° C., 250° C., or any value therebetween. For example, the heated gas temperature may be greater than 135° C. In another example, the heated gas temperature may be less than 250° C. In yet other examples, the heated gas temperature may be any value in a range between 135° C. and 250° C. In some embodiments, it may be critical that the heated gas temperature is greater than 170° C. to compress the hydrogen gas to a sufficient pressure.

The cooling system may cool the compressed hydrogen gas to a cooled hydrogen gas. The cooled hydrogen gas may be cooled to a cooled temperature. As discussed herein, the heat transfer system may include a heat transfer media. The heat transfer media may be heated to approximately the cooled temperature of the cooled hydrogen gas. The heat transfer media may transfer the heat to another location, such as a thermal store and/or a steam generation system.

In some embodiments, the cooled temperature may be in a range having an upper value, a lower value, or upper and lower values including any of 100° C., 105° C., 110° C., 115° C., 120° C., 125° C., 130° C., or value therebetween. For example, the cooled temperature may be greater than 100° C. In another example, the cooled temperature may be less than 130° C. In yet other examples, the cooled temperature may be any value in a range between 100° C. and 130° C. In some embodiments, it may be critical that the cooled temperature is greater than 105° C. to allow the absorbed heat to boil the input water to the steam generator. In some embodiments, it may be critical that the cooled temperature is greater than or equal to the boiling temperature of water at atmospheric temperature to allow the absorbed heat to boil the input water to the steam generator. In some embodiments, it may be critical, to allow the cooling system to provide some cooling to the compressed gasses, that the cooled temperature is at least 10° C. cooler than the heated gas temperature.

When the cooled hydrogen gas is cooled to the cooled temperature, the cooled hydrogen gas may be transferred to a storage system. The storage system may include one or more separators to separate any contaminants from the cooled hydrogen gas. In some embodiments, the storage system may be a storage tank to store compressed gas. In some embodiments, the storage system may include a solid-state storage system, such as a material that may adsorb the cooled hydrogen gas for storage. In some embodiments, the storage system may include any storage system to store the cooled hydrogen gas.

In some embodiments, the storage system may include a transfer system to transfer the compressed gas to another location. For example, the storage system may include a set of pipes that may transport the cooled hydrogen gas to another location. The transfer system may transfer the cooled hydrogen gas to any location. For example, the cooled hydrogen gas may be ultimately used at an ammonia production reactor, as discussed herein. In some examples, the cooled hydrogen gas may ultimately be used at a hydrogen electricity generator. In some examples, the cooled hydrogen gas may ultimately be used in a fuel cell. In some examples, the cooled hydrogen gas may be used in any other manner.

In some situations, to reach a target pressure, a compression and cooling system may include multiple stages of compressors and cooling systems. For example, the compressor may not be able to compress the hydrogen gas to a target pressure in a single stage. This may be due to the heated gas temperature of the compressed hydrogen gas being higher than an operating temperature of the compressor. To reach the target pressure, the compression and cooling system may include multiple stages of compressors and/or cooling systems.

As a specific, non-limiting example, FIG. 9 is a representation of a multi-stage compression and cooling system having multiple stages of compressors and cooling systems, according to at least one embodiment of the present disclosure. Gas may be fed into a first compressor. The gas may include any type of gas, such as hydrogen gas, oxygen gas, atmospheric gas, ammonia gas, any other gas, and combinations thereof. In some embodiments, the gas may be an output of an electrolyzer. For example, the gas may include the outputted oxygen gas and hydrogen gas from an electrolysis system. In some embodiments, the gas may include a single pure gas. In some embodiments, the gas may include a mixture of multiple gasses. The first compressor may compress the gas to a first high-temperature gas. A first cooling system may cool the first high-temperature gas to a first cooled gas. The first cooled gas may be fed into a second compressor and the second compressor may compress the first cooled gas to a second high-temperature gas. A second cooling system may cool the second high-temperature gas to a second cooled gas. The second cooled gas may be transferred to a storage system. While the embodiment in described as included two stages of compressors and cooling systems, it should be understood that the present disclosure is applicable to any number of stages of compressors and cooling system. For example, multi-stage compression and cooling systems of the present disclosure may include 1, 2, 3, 4, 5, 6, 7, 8, 9, 10, 11, 12, 13, 14, 15, 16, 17, 18, 19, 20, or more stages. In some embodiments, the number of stages may be based on the heated gas temperature and/or the cooled gas temperature. For example, the number of stages may be increased if the heated gas temperature is relatively lower, because the compressor for each stage may compress each stage to a relatively lower pressure increase by stopping at a lower temperature. In some examples, the number of stages may be decreased if the heated gas temperature is relatively higher, because the compressor for each stage may compress each stage to a relatively higher pressure increase by stopping at a higher temperature. In some examples, the number of stages may be decreased if the cooled gas temperature is relatively lower, because the compressor for each stage may compress each stage to a relatively higher pressure increase by starting at a lower temperature. In some examples, the number of stages may be increased if the cooled gas temperature is relatively higher, because the compressor for each stage may compress each stage to a relatively lower pressure increase by starting at a higher temperature.

Conventionally, compression and cooling systems seek to reduce the number of compression stages in the system. This may reduce capital and/or operating costs by reducing the number of compressors and/or cooling systems. In some situations, conventional compression and cooling systems may cool a gas to below the boiling point of water, which may decrease the number of stages, as discussed above.

In accordance with at least one embodiment of the present disclosure, the cooling systems may transfer at least a portion of absorbed heat to a heat transfer system. For example, the first cooling system may cool the first high-temperature gas, resulting in first absorbed heat. The first absorbed heat may be transferred to the heat transfer system. For example, the heat transfer system may be in thermal communication with the first cooling system. When the first cooling system cools the first high-temperature gas, the heat transfer system may receive the first absorbed heat from the first cooling system. The second cooling system may cool the second high-temperature gas, resulting in second absorbed heat. The second absorbed heat may be transferred to the heat transfer system. For example, the heat transfer system may be in thermal communication with the second cooling system. When the second cooling system cools the second high-temperature gas, the heat transfer system may receive the second absorbed heat from the second cooling system.

The heat transfer system may transfer the absorbed heat to be recycled in a separate portion of a system. For example, as discussed herein, the heat transfer system may transfer the absorbed heat to be recycled by a steam generation system to generate steam for steam electrolysis. In some examples, the heat transfer system may transfer the absorbed heat to be used by any other system, including to pre-heat gas used in ammonia generation, to pre-heat steam used in steam electrolysis, in a desalination system, to generate steam to facilitate hydrogen combustion, for any other use, and combinations thereof.

As will be understood, each stage of the multi-stage compression and cooling system (where a stage includes a compressor and a cooling system) may have an associated heated gas temperature (e.g., the temperature of the high-temperature gas) and a cooled gas temperature (e.g., the temperature of the cooled gas). In some embodiments, each stage may have the same heated gas temperature. For example, each compressor may compress the input gas until the gas reaches the heated gas temperature. In this manner, the heated gas temperature may be a temperature threshold to which the compressors compress the input gas. In some embodiments, different stages may have different heated gas temperatures. For example, different stages may have different compressors having different specifications, resulting in different heated gas temperatures. In some examples, the input gasses to different compressor stages may have different input pressures, with later stages having higher gas input pressure. Different compressors may be used for different input pressures. This may result in different heated gas temperatures.

In some embodiments, each stage may have the same cooled gas temperature. For example, the cooling systems may cool the cooled gas to the same cooled gas temperature. As discussed herein, the cooled gas temperature of each stage may be higher than the boiling point of water. This may allow the absorbed heat to be used to generate steam. In some examples, the cooled gas temperature for different stages may be different. For example, one or more of the stages may cool the compressed gas to a cooled gas temperature that is associated with an input temperature for a particular compressor. In this manner, the heated gas temperature and/or the cooled gas temperature may be tailored to the compressors of the stages of the multi-stage compression and cooling system.

In some embodiments, a temperature and compression chart for a multi-stage compression and cooling system includes stages on the horizontal axis (x-axis), pressure on the left vertical axis (left y-axis), and heat recovery on the right vertical axis (right y-axis). The temperature and compression chart includes a low temperature compression line and associated low temperature heat absorption line, each of which are associated with a low cooled gas temperature (e.g., below the boiling point of water). The temperature and compression chart further includes a high temperature compression line and associated high temperature heat absorption line, each of which are associated with a high cooled gas temperature (e.g., above the boiling point of water).

The relationship between the compression lines and the heat absorption lines may indicate how much heat is capable of being absorbed to reach a particular pressure. As may be seen, for a particular point on the compression lines, the high temperature heat absorption line indicates that more heat is absorbable per stage.

As a specific, non-limiting example, a conventional compression and cooling system may cool the compressed gas to 75° C. during cooling. This may result in between 6 and 7 stages of cooling to reach 700 Bar pressure. The theoretical heat energy recovery possible is 2.75 kWhr/kg H₂ by intercooling from 170° C. to 75° C. after each stage of compression. However, when considering steam generation at a pressure of 1 bar, only thermal sources above 100° C. can provide sufficient heat input to generate the steam. Thermal recovery from 100-75° C. is only possible to pre-heat water to the boiler, or an upstream flash desalination process leading to an addition 35% loss and an actual heat recovery of 1.75 kWhr/kg H₂. Only 47% of the 3.72 kWhr/kg H₂ steam duty.

In accordance with at least one embodiment of the present disclosure, cooling the compressed gas from 170° C. to 110° C. may result in a total recoverable energy of 2.95 kWhr/kg H₂, all of which is a high enough temperature to generate steam at 1 bar, amount to 79% of the steam duty of 3.72 kWhr/kg H₂. As may be seen, targeting a higher cooled gas temperature allows for the collection of more energy suitable for steam generation during cooling. In this manner, cooling the gas in accordance with embodiments of the present disclosure may result in recovered heat that is more usable (e.g., as a mechanism to generate steam) and recovers a larger portion of the heat from the steam duty, thereby increasing the overall efficiency of the system. In some embodiments, the collected heat may be sufficient to cover all steam-generation heat requirements.

In some embodiments, as discussed herein, pure oxygen generated during electrolysis may be collected. A separate compressor train for oxygen may be utilized and heat recovery could also be performed during compression of this additional gas stream in a similar manner. Furthermore, cooling compressed gas below 100° C. can still provide valuable heat to an upstream boiler water feed pre-heat or flash desalination process, the optimum intercooling temperature requires a specific techno-economic analysis.

In some embodiments, a multi-stage compression and cooling system having multiple stages of compressors and cooling systems, according to at least one embodiment of the present disclosure. A steam generator may receive liquid water and convert the liquid water into steam. The steam may be input into a steam electrolyzer. The steam electrolyzer may generate hydrogen gas. The hydrogen gas may be fed into a first compressor. The first compressor may compress the to a first high-temperature gas. A first cooling system may cool the first high-temperature gas to a first cooled gas. The first cooled gas may be fed into a second compressor and the second compressor may compress the first cooled gas to a second high-temperature gas. A second cooling system may cool the second high-temperature gas to a second cooled gas. The second cooled gas may be transferred to a storage system.

While the embodiment is described as included two stages of compressors and cooling systems, it should be understood that the present disclosure is applicable to any number of stages of compressors and cooling system. For example, multi-stage compression and cooling systems of the present disclosure may include 1, 2, 3, 4, 5, 6, 7, 8, 9, 10, 11, 12, 13, 14, 15, 16, 17, 18, 19, 20, or more stages.

In accordance with at least one embodiment of the present disclosure, the cooling systems may transfer at least a portion of absorbed heat to a heat transfer system. For example, the first cooling system may cool the first high-temperature gas, resulting in first absorbed heat. The first absorbed heat may be transferred to the heat transfer system. For example, the heat transfer system may be in thermal communication with the first cooling system. When the first cooling system cools the first high-temperature gas, the heat transfer system may receive the first absorbed heat from the first cooling system. The second cooling system may cool the second high-temperature gas, resulting in second absorbed heat. The second absorbed heat may be transferred to the heat transfer system. For example, the heat transfer system may be in thermal communication with the second cooling system. When the second cooling system cools the second high-temperature gas, the heat transfer system may receive the second absorbed heat from the second cooling system.

The heat transfer system may transfer the absorbed heat to the steam generator. The absorbed heat may be utilized by the steam generator to heat the liquid water input into the steam generator to generate the steam. In this manner, as discussed herein, absorbed heat may be used to reduce the energy input into the steam generator. This may increase the overall efficiency of the multi-stage compression and cooling system.

In some embodiments, a steam electrolysis system includes a steam electrolyzer. The steam electrolyzer may separate water into its component portions (e.g., hydrogen gas and oxygen gas). A steam generator may generate steam and pass the steam to the steam electrolyzer. The steam electrolyzer may generate hydrogen gas from the steam. The hydrogen gas may be passed to one or more compressors. During compression of the hydrogen gas by the compressors, the hydrogen gas may generate heat.

To maintain the hydrogen gas below an operating temperature of the compressors, a cooling system may cool the compressors and/or the hydrogen gas by absorbing the compression heat. The absorbed heat may be transferred to the steam generator using a heat transfer system. The absorbed heat may be used to generate at least a portion of the steam. This may help to reduce the energy expended by the steam generator to generate the steam. In some embodiments, this may help reduce and/or prevent the loss and/or waste of at least a portion of the heat generated by the compressors. Put another way, the heat transfer system may recycle at least a portion of the heat generated at the compressors through compression of the hydrogen gas.

In accordance with at least one embodiment of the present disclosure, the heat transfer system may transfer at least a portion of the absorbed heat from the compressors to a thermal store. The thermal store may store at least a portion of the absorbed heat for later use. The steam generator may be in thermal communication with the thermal store. When the steam generator generates steam, the steam generator may absorb heat from the thermal store to generate at least a portion of the steam used by the steam electrolyzer.

In some embodiments, all of the steam generated by the steam generator may be generated using the heat from the thermal store. In some embodiments, a portion of the steam generated by the steam generator may be generated using the heat from the thermal store. In some embodiments, the steam generator may generate team using the thermal store when the thermal store reaches a threshold level of absorbed heat. In some embodiments, the thermal store may be a buffer for heat generated by the compressors if the generated heat exceeds the heat usage by the steam generator.

In some embodiments, at least a portion of the heat from the heat transfer system and/or the thermal store may be used by the steam electrolyzer. For example, the steam electrolyzer may use the heat from the heat transfer system and/or the thermal store may be used to pre-heat steam or other components of the steam electrolyzer, thereby reducing the energy consumption of the steam electrolyzer.

The thermal store may be any type of thermal storage and/or utilize any mechanism to store thermal energy. For example, the thermal store may include a phase-change material. The phase-change material may change from solid to liquid at a temperature that approximately matches the temperature of the absorbed heat in the heat transfer system. The absorbed heat may melt the phase-change material, thereby storing the heat in the thermal energy used to melt the phase-change material. When the steam generator is ready to receive the absorbed heat, the input water may be passed through the melted phase-change material, and heat may pass from the melted phase-change material to the water, thereby causing the water to boil and convert to the steam. The phase-change material may include any phase-change material, including waxes, metal alloys, and so forth.

In some embodiments, the thermal store may be charged using electricity. For example, the thermal store may be charged using electricity from the power grid. This may allow the thermal store to be charged at times when the compressors are not producing heat. In some embodiments, the thermal store may be charged during non-peak electricity time. This may help to reduce the operating cost of the steam generator. In some embodiments, the thermal store may be charged (e.g., the thermal store is chargeable) using alternative energy and/or intermittent energy sources, such as solar energy, wind energy, any other alternative energy, and combinations thereof. In some embodiments, the thermal store may be charged (e.g., the thermal store is chargeable) using on-site energy generation. In some embodiments, the thermal store may be charged (e.g., the thermal store is chargeable) by absorbing heat from the sun. For example, the thermal store may be the focus of one or more solar collectors that may focus the thermal energy of the sun at the thermal store. The solar collectors may include any solar collector, such as mirrors, magnifying lenses, geodesic domes, any other solar collector, and combinations thereof.

In some embodiments, a steam electrolysis system includes a steam electrolyzer. The steam electrolyzer may separate water into its component portions (e.g., hydrogen gas and oxygen gas). A steam generator may generate steam and pass the steam to the steam electrolyzer. The steam electrolyzer may generate hydrogen gas from the steam. The hydrogen gas may be passed to one or more compressors. During compression of the hydrogen gas by the compressors, the hydrogen gas may generate heat. To maintain the hydrogen gas below an operating temperature of the compressors, a cooling system may cool the compressors and/or the hydrogen gas by absorbing the compression heat.

The compressed hydrogen gas may be transferred to a generator. The generator may be a hydrogen combustion generator. The generator may combust the hydrogen gas, thereby generating electricity and thermal energy. The electricity may be used in any manner. For example, the electricity may be transmitted to the grid, where it may be u sed at any location on the grid. In some examples, the electricity may be used in a local process. For example, the electricity may be used to at least partially power the steam electrolyzer and/or the steam generator.

In some embodiments, at least a portion of the generated heat may be transmitted to a thermal store. As discussed herein, the thermal store may store the generated heat for later use. For example, the thermal store may be used by the steam generator to generate the steam at the steam generator.

By combusting the hydrogen gas in the generator, the steam electrolysis system may help to improve the energy efficiency of the steam electrolysis system and/or reduce the energy consumption of the steam electrolysis system.

In some embodiments, a steam electrolysis system includes a steam electrolyzer. The steam electrolyzer may separate water into its component portions (e.g., hydrogen gas and oxygen gas). A steam generator may generate steam and pass the steam to the steam electrolyzer. The steam electrolyzer may generate hydrogen gas from the steam. The hydrogen gas may be passed to one or more compressors. During compression of the hydrogen gas by the compressors, the hydrogen gas may generate heat. To maintain the hydrogen gas below an operating temperature of the compressors, a cooling system may cool the compressors and/or the hydrogen gas by absorbing the compression heat.

The compressed and cooled gas may be used in a generator to generate electricity. The compressed and cooled gas may first be collected and/or transmitted to the generator using a storage and transportation system. Combustion of the hydrogen gas in the generator results in heat and water vapor.

As discussed herein, the heat generated during combustion of the hydrogen gas may be transferred and/or absorbed by a thermal store. The thermal store may absorb the heat and transmit the heat to one or more of the steam generator or the steam electrolyzer. For example, the thermal store may be in thermal communication with the electricity, the steam generator, and the steam electrolyzer. During operation of the steam generator, heat in the thermal store may be used to generate steam and/or pre-heat the steam prior to electrolysis in the steam electrolyzer. In some embodiments, heat from the thermal store may be used to provide heat for electrolysis in the steam electrolyzer.

As discussed herein, heat generated by compression of the hydrogen gas may be transferred to the thermal store and/or the steam generator.

In some embodiments, heat from the generator may be absorbed by the thermal store at a temperature higher than the boiling point of water. In some embodiments, the heat from the generator may be absorbed by the thermal store at a temperature higher than heat generated and absorbed from the compressors. This may be because the combustion of the hydrogen gas occurs at a higher temperature than the temperature of the compression of the hydrogen gas.

In some embodiments, the thermal store may include two sections. A first section of the thermal store may be a high-temperature section used to store heat generated during the combustion of hydrogen gas. A second section of the thermal store may be a low-temperature section used to store heat generated during the compression of the hydrogen gas. The absorbed heat from the different sections may be used for different purposes. For example, as discussed herein, heat from the second section may be used to generate steam at the steam generator. Heat from the first section may be used to further heat that steam to pre-heat it prior to electrolysis. In some embodiments, heat from the first section may be used to pre-heat gasses for the production of ammonia, as discussed in further detail herein.

In some embodiments, the generator may utilize a portion of the steam generated by the steam generator to facilitate the combustion of the hydrogen gas. Adding a portion of steam to the hydrogen and oxygen gas feeds may help to reduce the explosivity of the hydrogen and/or improve the combustion reaction.

In some embodiments, the water generated during combustion of the hydrogen gas may be captured as steam. The steam may be cooled, and the thermal energy stored in the thermal store. In some embodiments, the steam may be condensed and/or stored for later use in electrolysis by the steam electrolyzer. In some embodiments, the electricity generated by the generator may be used to power the steam electrolyzer.

In some embodiments, the oxygen generated by the steam electrolyzer may be collected at an oxygen gas collection system. The collected oxygen may be compressed by the compressors and/or stored by the storage and transportation system. The collected oxygen gas may be used at the generator during combustion of the hydrogen gas. Using oxygen gas may increase the efficiency of the combustion of the hydrogen gas in the generator.

In some embodiments, the steam electrolysis system may be a closed system. For example, the water generated during hydrogen combustion may be collected at a water collection system. If the water vapor condenses to a liquid, the liquid water may be converted to steam by the steam generator. The steam in the system (generated by the steam generator and/or stored from the combustion of the hydrogen gas) may be used by the steam electrolyzer to be separated into oxygen gas and hydrogen gas. The oxygen gas and hydrogen gas may be collected and stored (and optionally compressed by the compressors). The oxygen gas and hydrogen gas may be combusted at the generator and the cycle repeated. In this manner, the steam electrolysis system may be a closed system with respect to water. This may help to reduce the water consumption of the steam electrolysis system. This may help to improve the applicability of the steam electrolysis system in desert climates.

As discussed herein, recycling energy in the form of heat may help to increase the efficiency of the steam electrolysis system. This may help to reduce the amount of external energy utilized to operate the steam electrolyzer, the steam generator, and/or the compressors.

In some embodiments, the steam electrolysis system may be implemented as an energy storage system. For example, electricity may initially be input into the steam electrolyzer to generate hydrogen gas and oxygen gas. The hydrogen gas and oxygen gas may be stored until it is desirable to generate additional electricity. At this time, the generator may combust the hydrogen gas and the oxygen gas, generating electricity. In this manner, the energy input to electrolyze the water may be “stored,” and at least a portion of the energy may be recaptured during combustion of the hydrogen and oxygen. As discussed herein, capturing the generated heat and/or storing the generated heat may help to improve the efficiency of the steam electrolysis system, thereby improving the amount of energy recaptured during combustion.

The present disclosure relates to systems and methods for ammonia production according to any of the sections below:

[A1] In some embodiments, an ammonia production system includes a steam generation device configured to produce steam and an electrolyzer cell configured to produce hydrogen feedstock gas from the steam. A hydrogen combustor receives the hydrogen feedstock gas from the electrolyzer cell and combusts the hydrogen feedstock gas and produce heat and electricity. A combustion thermal conduit provides heat transfer between the hydrogen combustor and at least one component of the system. An electrical generator is connected to the hydrogen combustor and configured to generate electricity from the combustion.

[A2] In some embodiments, the hydrogen combustor of [A1] further produces nitrogen feedstock gas, and the system further comprises a compression train configured to compress the nitrogen feedstock gas.

[A3] In some embodiments, the compression train of [A1] or [A2] includes a plurality of compressors and at least one cooler, and the cooler is configured to maintain the nitrogen feedstock gas at no less than 105° C.

[A4] In some embodiments, the system of [A3] further includes a cooler thermal conduit configured to provide thermal transfer between the cooler and the at least one component of the system.

[A5] In some embodiments, the hydrogen combustor of any of [A1] through [A4] further produces vapor phase water, and the system further includes a condenser configured to receive the vapor phase water and condense the vapor phase water into liquid phase water.

[A6] In some embodiments, the condenser of [A5] is configured to separate at least a portion of the nitrogen feedstock gas from the liquid phase water.

[A7] In some embodiments, the system of [A6] includes a water conduit configured to provide the liquid phase water to the steam generation device.

[A8] In some embodiments, the system of any of [A1] through [A7] includes an ammonia reactor configured to receive at least part of the hydrogen feedstock gas.

[A9] In some embodiments, the system of any of [A1] through [A8] includes a combustion electrical conduit that provides electrical communication between the electrical generator and the electrolyzer cell.

[A10] In some embodiments, the system of any of [A1] through [A9] further comprises a variable renewable energy (VRE) source configured to provide electricity to at least one component of the system.

[A11] In some embodiments, the VRE source of [A10] includes at least one of a photovoltaic, solar thermal, wind, and geothermal energy source.

[A12] In some embodiments, the system of [A10] or [A11] is configured to convert heat from the VRE source into electricity using a thermal energy generation cycle.

[B1] In some embodiments, a method of producing ammonia includes producing steam with a steam generation device; delivering the steam to an electrolyzer cell; electrolyzing the steam to form hydrogen gas; providing the hydrogen gas from the electrolyzer cell to a hydrogen combustor; combusting the hydrogen gas with air to produce nitrogen feedstock, water, electricity, and heat; recycling the heat to the steam generation device; and recycling the electricity to the electrolyzer cell.

[B2] In some embodiments, recycling the heat to the steam generation device of [B1] includes receiving the heat at a thermal storage device.

[B3] In some embodiments, recycling the electricity to the electrolyzer cell of [B1] or [B2] includes receiving the electricity at an electrical storage device.

[B4] In some embodiments, the electrical storage device of [B3] is a battery.

[B5] In some embodiments, the method of any of [B1] through [B4] includes recycling the water to the steam generation device.

[B6] In some embodiments, the method of any of [B1] through [B5] further including: compressing the nitrogen feedstock; and recycling compression heat from the nitrogen feedstock to the steam generation device.

[B7] In some embodiments, the method of any of [B1] through [B6] further comprises providing electricity to at least one component of the system using a VRE source.

[B8] In some embodiments, the VRE source of [B7] includes at least one of a photovoltaic, solar thermal, wind, and geothermal energy source.

[B9] In some embodiments, the method of [A10] or [A11] includes converting heat from the VRE source into electricity using a thermal energy generation cycle.

[C1] In some embodiments, a system for ammonia production includes a thermal energy generation cycle, a steam generation device, and an electrolyzer cell. The thermal energy generation cycle is configured to produce electricity. The steam generation device is configured to produce steam. The electrolyzer cell is configured to produce hydrogen feedstock gas from the steam. A hydrogen combustor is configured to receive the hydrogen feedstock gas from the electrolyzer cell and combust the hydrogen feedstock gas and produce nitrogen feedstock gas, heat, and electricity. A first combustion thermal conduit provides thermal transfer between the hydrogen combustor and the steam generation device. A second combustion thermal conduit that provides thermal transfer between the hydrogen combustor and the thermal energy generation cycle. An electrical generator is connected to the hydrogen combustor and generates electricity from the combustion performed by the hydrogen combustor. An ammonia reactor is configured to receive the hydrogen feedstock gas and the nitrogen feedstock gas.

[C2] In some embodiments, the thermal energy generation cycle of [C1] is configured to receive heat from a solar thermal generator.

[C3] In some embodiments, the thermal energy generation cycle of [C1] or [C2] operates with an operating temperature of no more than 100° C.

[C4] In some embodiments, the system of any of [C1] through [C3] further includes a compression train includes a plurality of compressors configured to compress at least one of the nitrogen feedstock gas and the hydrogen feedstock gas, and the compression train is configured to transfer compression heat from the at least one of the nitrogen feedstock gas and the hydrogen feedstock gas to the steam generation device.

[C5] In some embodiments, at least one of the nitrogen feedstock gas and the hydrogen feedstock gas of [C4] is above 105° C. throughout the compression train.

[D1] The disclosure also relates to an electrolysis system, comprising a heating device for heating water above its boiling point to produce a processed water product; an electrolyzer that receives the processed water product to produce hydrogen gas and oxygen based on the processed water product; a compressor that receives hydrogen gas and compresses the hydrogen gas, the compressor heating the hydrogen gas to a heated gas temperature; a cooling system that cools the hydrogen gas from the heated gas temperature to a cooled temperature; and a heat transfer system that transfers absorbed heat from the cooling system to the steam generation device, the steam generation device producing steam at least in part using the absorbed heat.

[D2] In some embodiment, the system of [D1] wherein the cooled temperature is greater than a boiling point of water at atmospheric pressure, especially above 105° C., optionally approximately 110° C.

[D3] In some embodiment, the system of [D1] or [D2], wherein the compressor includes a plurality of stages.

[D4] In some embodiment, the system of [D1] to [D3], wherein the heat transfer system further comprises a thermal storage system in thermal communication with the steam generation device. In such embodiment, the thermal storage system may include a solid-to-liquid phase-change material. In such embodiment the thermal storage system may be chargeable by the absorbed heat and discharged by the heating device. In such embodiment, the thermal storage system is chargeable with electricity such as solar energy.

[D5] In some embodiment, the system of [D1] to [D4], wherein the compressor receives oxygen gas from the electrolyzer and compresses the oxygen gas.

[D6] In some embodiment, the system of [D1] to [D5], the heating device includes a steam generator and the processed water product is steam. In such embodiment, the electrolyzer may be a steam electrolyzer producing hydrogen and oxygen gas from steam.

[D7] In some embodiment, the system of [D1] to [D6], the heating device includes a flash desalination device and the processed water product is desalinated water. Such desalinated water may be routed to the electrolyzer (ie low temperature electrolyzer) or a steam generator coupled to a high temperature electrolyzer.

[E1] The disclosure also relates to a method for electrolysis, comprising compressing hydrogen gas to a heated gas temperature in a compression system; cooling the compressed hydrogen gas to a cooled temperature in a cooling system, wherein the cooled temperature is greater than a boiling point of water at atmospheric pressure, wherein cooling the compressed hydrogen gas includes absorbing absorbed heat from the compressed hydrogen gas; using the absorbed heat, heating water above its boiling point to produce a processed water product; and using the processed water product, performing electrolysis to produce electrolyzed hydrogen gas and oxygen gas.

[E2] In some embodiments, in the method of [E1], compressing the hydrogen gas includes compressing the electrolyzed hydrogen gas generated using electrolysis.

[E3]. In some embodiments, in the method of any of [E1] or [E2], the cooled temperature is above 105° C., optionally around 110° C.

[E4]. In some embodiments, in the method of any of [E1] to [E3], heating water above its boiling point to produce a processed water product includes one or more of using a steam generator to produce steam and using a flash desalination device to produce desalinated water.

[E5] In some embodiments, the method of any of any of [E1] to [E4] further comprises storing at least a portion of the absorbed heat in a thermal store.

In at least some embodiments of the present disclosure, an ammonia production system, or subsystems thereof, uses a hydrogen combustor to produce nitrogen feedstock gas for ammonia production. The ammonia production system, or subsystems thereof, recycles at least a portion of produced heat and electricity to reduce the overall energy consumption and carbon usage of the ammonia production system.

While embodiments disclosed herein may be used in the ammonia production environments, such environments are merely illustrative. Systems, tools, assemblies, methods, devices, and other components of the present disclosure, or which would be appreciated in view of the disclosure herein, may be used in other applications and environments. In other embodiments, embodiments of the present disclosure may be used outside of an ammonia production environment, including in connection with the production of other compounds and, particularly, nitrogen-bearing compounds, or in the automotive, aquatic, aerospace, hydroelectric, manufacturing, or telecommunications industries.

In the description herein, various relational terms may be used to facilitate an understanding of various aspects of some embodiments of the present disclosure. Relational terms such as “bottom,” “below,” “top,” “above,” “back,” “front,” “left,” “right,” “rear,” “forward,” “up,” “down,” “horizontal,” “vertical,” “clockwise,” “counter clockwise,” “upper,” “lower,” and the like, may be used to describe various components, including their operational or illustrated position relative to one or more other components. Relational terms do not indicate a particular orientation for each embodiment within the scope of the description or claims but are intended for convenience in facilitating reference to various components. Thus, such relational aspects may be reversed, flipped, rotated, moved in space, placed in a diagonal orientation or position, placed horizontally or vertically, or similarly modified.

Certain descriptions or designations of components as “first,” “second,” “third,” and the like are also used to differentiate between identical components or between components which are similar in use, structure, or operation. Such language is not intended to limit a component to a singular designation or require multiple components. As such, a component referenced in the specification as the “first” component may be the same or different than a component that is referenced in the claims as a “first” component, and a claim may include a “first” component without requiring the existence of a “second” component.

Furthermore, while the description or claims may refer to “an additional” or “other” element, feature, aspect, component, or the like, it does not preclude there being a single element, or more than one, of the additional element. Where the claims or description refer to “a” or “an” element, such reference is not be construed that there is just one of that element but is instead to be inclusive of other components and understood as “at least one” of the element. It is to be understood that where the specification states that a component, feature, structure, function, or characteristic “may,” “might,” “can,” or “could” be included, that particular component, feature, structure, or characteristic is provided in certain embodiments, but is optional for other embodiments of the present disclosure. The terms “couple,” “coupled,” “connect,” “connection,” “connected,” “in connection with,” and “connecting” refer to “in direct connection with,” or “in connection with via one or more intermediate elements or members.” Components that are “integral” or “integrally” formed include components made from the same piece of material, or sets of materials, such as by being commonly molded or cast from the same material, in the same molding or casting process, or commonly machined from the same piece of material stock. Components that are “integral” should also be understood to be “coupled” together.

Additionally, references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

Although various example embodiments have been described in detail herein, those skilled in the art will readily appreciate in view of the present disclosure that many modifications are possible in the example embodiments without materially departing from the present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The Abstract at the end of this disclosure is provided to allow the reader to quickly ascertain the general nature of some embodiments of the present disclosure. It is submitted with the understanding that it will not be used to interpret or limit the scope or meaning of the claims.

What is claimed is:

1. An electrolysis system, comprising:
a heating device for heating water above its boiling point to provide a processed water product;
an electrolyzer that receives the processed water product to produce hydrogen gas and oxygen based on the processed water product;
a compressor that receives hydrogen gas and compresses the hydrogen gas, the compressor heating the hydrogen gas to a heated gas temperature;
a cooling system that cools the hydrogen gas from the heated gas temperature to a cooled temperature; and
a heat transfer system that transfers absorbed heat from the cooling system to the heating device, the heating device providing the processed water product at least in part using the absorbed heat.

2. The electrolysis system of claim 1, wherein the cooled temperature is greater than a boiling point of water at atmospheric pressure.

3. The electrolysis system of claim 2, wherein the cooled temperature is above 105° C.

4. The electrolysis system of claim 3, wherein the cooled temperature is approximately 110° C.

5. The electrolysis system of claim 1, wherein the compressor includes a plurality of stages.

6. The electrolysis system of claim 1, wherein the heat transfer system further comprises a thermal storage system in thermal communication with the heating device.

7. The electrolysis system of claim 6, wherein the thermal storage system includes a solid-to-liquid phase-change material.

8. The electrolysis system of claim 6, wherein the thermal storage system is chargeable by the absorbed heat and discharged by the heating device.

9. The electrolysis system of claim 6, wherein the thermal storage system is chargeable with electricity.

10. The electrolysis system of claim 9, wherein the thermal storage system is chargeable with solar energy.

11. The electrolysis system of claim 1, wherein the heating device includes one or more of a steam generator to produce steam and a flash desalination device to produce desalinated water.

12. The electrolysis system of claim 1, wherein the compressor receives oxygen gas from the electrolyzer and compresses the oxygen gas.

13. A method for electrolysis, comprising:
compressing hydrogen gas to a heated gas temperature in a compression system;
cooling the compressed hydrogen gas to a cooled temperature in a cooling system, wherein the cooled temperature is greater than a boiling point of water at atmospheric pressure, wherein cooling the compressed hydrogen gas includes absorbing absorbed heat from the compressed hydrogen gas;
using the absorbed heat, heating water above its boiling point to produce a processed water product; and
using the processed water product, performing electrolysis to produce electrolyzed hydrogen gas and oxygen gas.

14. The method of claim 13, wherein compressing the hydrogen gas includes compressing the electrolyzed hydrogen gas generated using electrolysis.

15. The method of claim 13, wherein the cooled temperature is above 105° C., optionally around 110° C.

16. The method of claim 13, wherein heating water above its boiling point to produce a processed water product includes one or more of using a steam generator to produce steam and using a flash desalination device to produce desalinated water.

17. The method of claim 13, further comprising storing at least a portion of the absorbed heat in a thermal store.
